(19) United States
(12) Patent Application Publication
(10) Pub. No.: US 2011/0180385 A1
(43) Pub. Date: Jul. 28, 2011

(54) Control of Catalytic Chemical Processes

(75) Inventor: Timothy J. Imholt, Methuen, MA (US)

(73) Assignee: Raytheon Company, Waltham, MA (US)

(21) Appl. No.: 12/695,566

(22) Filed: Jan. 28, 2010

(51) Int. Cl. B01J 19/12; B01D 53/86; H05B 6/80; B01J 19/08

(52) U.S. Cl. 204/157.15; 422/186; 422/186.04; 422/186.3; 422/186.29; 977/902; 977/701; 977/742

(57) ABSTRACT

According to one embodiment, a method for controlling a chemical process comprises receiving a catalytic materials composition. The catalytic materials composition comprise at least one catalyst material and at least one reactant material. Nanostructure material is added to the catalytic materials composition. The nanostructure material comprises at least one nanoscale-sized space therein. The nanostructure material is irradiated with electromagnetic radiation such that the nanostructure material facilitates energy transfer between the nanostructure material and the catalytic materials composition.

### TECHNICAL FIELD

This disclosure generally relates to nanostructure materials, and more particularly, to control of catalytic chemical processes.

### BACKGROUND

Nanostructures may include any nanometer-scale structures. One example of a nanostructure is a nanotube, such as carbon nanotubes. Conceptually, a nanotube is a very small cylinder, typically capped at each end by a hemisphere of atoms, such as carbon atoms. There are two categories of nanotubes: multi-walled nanotubes (MWNT) and single-walled nanotubes (SWNT). MWNTs may be thought of as a number of layers of concentric pipes or tubes. MWNTs also include double-walled nanotubes and triple-walled nanotubes, which may exhibit different properties from SWNTs and other MWNTs.

### SUMMARY

According to one embodiment, a method for controlling a chemical process comprises receiving a catalytic materials composition. The catalytic materials composition comprise at least one catalyst material and at least one reactant material. Nanostructure material is added to the catalytic materials composition. The nanostructure material comprises at least one nanoscale-sized space therein. The nanostructure material is irradiated with electromagnetic radiation such that the nanostructure material facilitates energy transfer between the nanostructure material and the catalytic materials composition.

Certain embodiments of the disclosure may provide numerous technical advantages. For example, a technical advantage of one embodiment may include the capability to induce controlled temperature changes directly at reaction sites in surface-catalyzed chemical processes. Yet another technical advantage of one embodiment may include the capability to eliminate thermal lag caused by a reaction vessel or chamber. Yet another technical advantage of one embodiment may include the capability to efficiently convert long wavelength electromagnetic radiation into thermal energy. Yet another technical advantage of one embodiment may include the capability to provide precise local control of the thermal conditions at the localized catalytic reaction site.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of embodiments of the disclosure and its advantages, reference is now made to the following detailed description, taken in conjunction with the accompanying drawings, in which:

FIG. 1 shows a reaction system 100 according to one example embodiment;

FIG. 2 shows an image metal particle decorated nanotubes;

FIG. 3 shows a Schematic illustration of a generalized apparatus or any other implementation which can be configured to utilize the effects of electromagnetic irradiation of carbon nanotubes;

FIG. 4 shows a brilliant light emitted from a SWNT sample upon the start of microwave irradiation;

FIG. 5 shows local melting of a tube holding a SWNT sample had occurred in the vicinity of the SWNT sample;

FIGS. 6A and 6B show SEM images of a 1.1 nm average diameter SWNT sample before and after 6 second irradiation of 2.45 GHz microwaves from a magnetron source having the above described reflector and operating with a 50 W total output power;

FIG. 7 shows the typical Raman spectra (514.5 nm excitation) of single wall nanotubes before and after 6 second microwave irradiation; and

FIG. 8 shows an example of the microwave irradiated SWNT light emission spectra.

### DETAILED DESCRIPTION OF EXAMPLE EMBODIMENTS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Teachings of certain embodiments recognize that the rates and efficiencies of useful surface-catalyzed chemical processes may depend on the temperature of the reactants at the time of the reaction and in the vicinity of the catalytic reaction region. However, the control of such temperatures may require external heating of the entire reaction vessel or chamber and surroundings with attendant inefficiencies of cost from the thermal delivery and attendant inefficiencies of rapid control of temperature because of the thermal lag of the reaction vessel or chamber

Accordingly, teachings of certain embodiments recognize that such temperatures may be precisely and rapidly controlled in the immediate, even nanoscale, vicinity of the catalytic surfaces and reactants by adding carbon nanotubes in the catalytic materials composition and inducing controlled temperature changes directly at the reaction sites by standoff application of electromagnetic radiation onto the carbon nanotubes in the mixture. Although examples described herein refer to carbon nanotubes, teachings of certain embodiments recognize that any suitable structures of any suitable material may be used.

Teachings of certain embodiments recognize that a collection or dispersion of carbon nanotubes may be irradiated with electromagnetic waves under selected conditions so as to produce localized energy transfer; when irradiated, the collection or dispersion of carbon nanotubes may control the rates, progress, and efficiency of chemical catalytic processes when admixed with or chemically attached to or contiguous with or otherwise near in any suitable position to chemical catalyst materials, such as particles, clusters or other objects with catalytically active surfaces.

Furthermore, heterogeneous catalysis of a chemical reaction occurs when a suitable surface of a material, the catalyst, typically a solid, is allowed to contact a single chemical reactant or a mixture of reactants with the result that a chemical reaction ensues to produce a desirable product that normally would not form at a desirable rate under conditions with the absence of the catalyst. In some examples, the catalytic effect may be maximized for a given amount of catalyst material by maximizing the ratio of the surface area to the mass of the catalyst material.

Teachings of certain embodiments recognize the ability to maximize the ratio of surface area to mass of catalyst material by producing extremely small catalyst material objects, even down to the nanometer scale. In such cases, the extremely small catalytic objects may be utilized by attaching them in some way to a support material. Example support materials may include high surface area ceramic materials, such as metal oxides, including SiO2 and AI2O3, to name two for example; and high surface area carbon, added as a graphitic material, carbon black, or activated charcoal, for example, or in the form of other nanometer scale sized objects such as nanotubes.

Carbon nanotubes may be compatible with any catalytic reaction that does not degrade the carbon nanotubes to non-useful forms such as CO2, regardless of whether the carbon nanotubes are added as a support or other use such as an energy transfer or production source. In addition, given the high stability of carbon nanotubes, even some catalytic oxidation processes may be tolerated if the oxidation conditions are sufficiently mild such that the catalyst feedstock is satisfactorily reacted while the carbon nanotubes do not suffer significant damage. Such reactions may include, but are not limited to: hydrogenation, dehydrogenation, cracking, reforming, synthetic gasoline (syngas) production (1Fischer-Tropsch process), and nitrogen fixation (Haber ammonia process), to name a few.

Table 1, below, presents a non-exhaustive summary of some of the processes that could be incorporated with teachings of certain embodiments.

TABLE 1
Selected Industrial Heterogeneous Catalysis Processes.

| | Typical Feedstock and Associated |
|---|---|
| Type of Process | Catalyst Material(s) |
| Hydrogenolysis | Ethane: Ni |
| | Methylcyclopentane: Pt |
| Isomerization | Isobutane: Pt |
| | Hexane: Pt |
| Cyclization | Hexane: Pt |
| | Heptane: Pt |
| N₂ Fixation to | Ammonia: Fe, Rh |
| Ammonia (Haber Process) | |
| Hydrodesulfurization | Thiophene: Re, Mo |
| Ring Opening | Cyclopropane: Pt |
| Hydrogenation | Benzene: Pt |
| | Ethylene: Pt, Rh |
| | Carbon Monoxide. Ni, Rh, Ru, Mo, Re |
| Dehydrogenation | Cyclohexane: Pt |

Data taken from Introduction to Surface Chemistry and Catalysis, G. A. Somorjai, Wiley-lnterscience, NY, 1994, p. 592

Some industrial processes (typical catalysts in parentheses) could include, but are not limited to: NOx reduction (typically carried out in automobile exhausts using Pt and Pd), cracking of crude oil (zeolites), hydrotreating of crude oil (Co—Mo, Ni—Mo, W—Mo), reforming of crude oil (Pt, Pt—Re and other bimetallics), steam reforming (Ni), water-gas shift reaction (Fe—Cr, CuO, ZnO, AI2O3), methanation (Ni), ethylene oxidation (Ag), acrylonitrile from propylene (Bi, Mo-oxides), vinyl chloride from ethylene (Cu-chloride), hydrogenation of oils (Ni) and polyethylene synthesis (Cr, CrOxide). Data taken from Introduction to Surface Chemistry and Catalysis, G. A. Somorjai, Wiley-Interscience, NY, 1994, p. 592. Such reactions may also include electrochemical catalysis in which electrical current is used in conjunction with a catalytically active surface to accelerate the formation of a desired reaction product or with the intention of using the exothermic energy of such a catalytic process to create transferable energy, such as is done in a fuel cell.

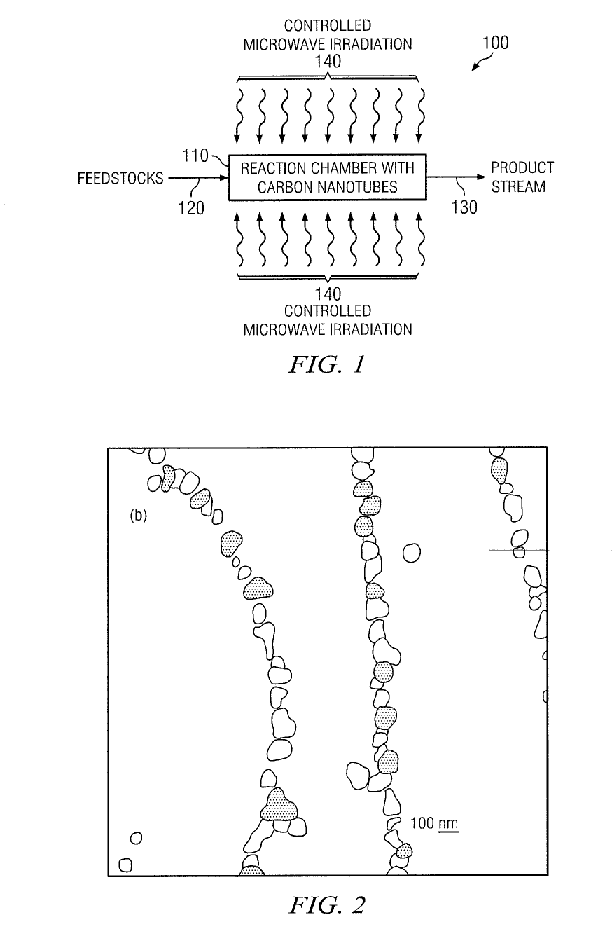

FIG. 1 shows a reaction system 100 according to one example embodiment. Reaction system 100 is for illustrative purposes only and represents one possible configuration.

Reaction system 100 features a reaction chamber 110, an incoming supply of feedstocks 120, and a outgoing product stream 130. In this example, reaction chamber 110 includes a catalytic reaction mixture with carbon nanotubes. Reaction system 100 irradiates reaction chamber 110 with controlled microwave irradiation 140. Teachings of certain embodiments recognize that microwaves 140 may cause heating and activation of reactants and catalysts in reaction chamber 110, which provides a catalytic reaction yielding the desired product controlled microwave irradiation.

In some cases, such as for radiation ranging from about 1 gigahertz to about 1 terahertz, the thermal energy produced therein may be greater than equal to or less than the energy required carrying out the electromagnetic radiation. Thus, long wavelength may efficiently convert to thermal energy conversion, such as with an energy gain or release (i.e. more thermal energy out than microwave energy in), in the vicinity of the catalytic process. Control of the irradiation geometry, frequency, time intervals, and power can provide precise local control of the thermal conditions at the localized catalytic reaction site. Such control may provide significant improvements in the ability to precisely control the reaction conditions for optimal product yield and can result in increases in the efficiencies of the catalytic processing.

Conceptually, a nanotube is a very small cylinder, typically capped at each end by a hemisphere of atoms, such as carbon atoms. There are two categories of nanotubes: multi-walled nanotubes (MWNT) and single-walled nanotubes (SWNT). MWNTs may be thought of as a number of layers of concentric pipes or tubes. MWNTs also include double-walled nanotubes and triple-walled nanotubes, which may exhibit different properties from SWNTs and other MWNTs.

SWNTs are nanotubes with only a single shell of atoms. The structure of a SWNT can be conceptualized by wrapping a one-atom-thick layer of atoms into a seamless cylinder. In this manner, SWNTs can be thought of as little pipes or tubes with diameters typically ranging from, but not limited to, approximately 0.6 to 5.0 nanometers. The lengths of SWNTs can range from a few hundred nanometers to several centimeters in length.

In some embodiments, the nanoscale sized space in the material comprises one or more filled or unfilled cavities or voids in the material having a smallest dimension of less than 1.2 nanometers. The nanoscale sized space may be a substantially cylindrical enclosed cavity in the material having a diameter of less than 1.2 nanometers. For example, a substantially cylindrical cavity has a shape that is or resembles a cylinder, but may not necessarily have a straight sidewall and/or may not necessarily have flat upper and lower bases. The cavity or void may be filled with atoms or molecules that are not part of the lattice of the material or the cavity or void may be left unfilled.

In some embodiments, the nanostructure material is a carbon material; however, teachings of certain embodiments recognize that the nanostructure material may comprise other non-carbon materials as well. In some embodiments, the material comprises carbon nanotubes and the nanoscale sized space comprises the internal space that is surrounded by the nanotube wall or walls. In some embodiments, the carbon nanotubes have an internal diameter of 1.2 nanometers or smaller, such as 1.1 nanometers or smaller.

In some embodiments, the nanotubes may comprise SWNTs or MWNTs. In some embodiments, the nanotubes may have an innermost diameter of 1.1 nanometers or smaller. In some embodiments, the internal space in the nanotubes is substantially cylindrical because it has curved rather than flat bases or ends. This internal space may be empty. In alternative embodiments, the internal space may be filled with hydrogen, oxygen, deuterium, tritium, lithium, or other atoms or molecules to effect differences in the amount of thermal energy and energetic particles which can be emitted during the electromagnetic irradiation of the nanotubes or other suitable materials, as will be described in more detail below.

It should be noted that non-carbon nanostructured materials, such as metal oxide hollow nanohorns or hollow nanowires having an internal diameter of 1.1 nm or less may also be used. Likewise, carbon and non carbon bulk material with nanoscale sized space therein may also be used. Furthermore, it is possible that carbon tips in the carbon nanotube act as pin point electron field emitters which contribute to the energy generation and conversion effect. Thus, any suitable material that contains carbon or other suitable tips which act as pin point electron field emitters may also be used.

In some embodiments, the carbon nanotubes comprise purified SWNTs. Some embodiments may prefer a higher or greater purity nanotubes. The nanotubes may be purified by any suitable purification method. Without wishing to be bound by a particular theory, it is believed that purification removes amorphous catalyst and unprocessed carbon precursor material from exterior of the nanotubes. It is believed that the purification increases the amount of pure nanotubes per unit volume, which increases the energy gain. Without wishing to be bound by a particular theory, it is believed that the energy gain is caused by a nanostructured material, such as carbon nanotubes. Thus, an increase in the amount of pure nanostructure material per unit volume increases the energy gain. Furthermore, in some embodiments, the nanotubes comprise highly dense carbon nanotubes. An example of highly dense nanotubes are BuckyPearl® nanotubes available from Carbon Nanotechnologies, Inc. (CNI) of Texas. Typical carbon nanotubes have a density of about 15 Mg/M3′ while BuckyPearl® nanotubes have a density of about 600 Mg/M3. Thus, in some embodiments, the density is above 100 mg/m3, such as 100 mg/m3 to 600 mg/m3. Without wishing to be bound by a particular theory, it is believed that an increase in the amount of pure nanostructure material per unit volume (i.e., density) increases the energy gain.

In some embodiments, the material may be irradiated with any suitable long wavelength radiation that produces an energy gain. For example, the frequency of the long wavelength radiation may range from about 1 GHz to about 1 terahertz, including from 1 to 90 GHz, such as from 2.4 to 12 GHz. Depending on the definition of the exact location of the imaginary boundary between radio frequency and microwave bands, the lower end of the 1 to 90 GHz range is either in or borders the radio frequency range, while the middle portion and upper end of this range are in the microwave range. In some embodiments, microwave radiation is used. Any suitable microwave radiation power may be used, such as a power of between 30 watts and 100 kW, such as between 30 watts and 1 kW.

In some embodiments, the material, such as carbon nanotubes, is irradiated with long wavelength radiation, such as with pulsed microwave radiation to provide an electric field that can range over a wide scale of values. For the highest energy output fields as high or greater than 10,000 V/cm may be required in the material but any field can be used for the particular purposes needed in a given catalytic process. When the local electric fields are large, e.g., 10,000 V/cm, and irridation is sufficiently long, energy gain and/or a plasma may be produced and used to advantage in the chemical catalytic process of interest. The energy gain and/or plasma may be generated almost instantaneously, such as in a fraction of a second after the application of the electric field or after a longer electric field application, such as an electric field application of at least 1 to 2 seconds, for example of at least 1 to 20 seconds, this field can continue for minutes or hours if need be.

For example, the electric field of at least about 10,000 V/cm may be provided in the carbon nanotubes for a sufficient time to generate the energy gain by several different methods. The carbon nanotubes tend to move around upon the irradiation with microwave radiation and thus may move out of the zone where sufficient microwave radiation exists to produce the sufficient electric field for the energy gain. Thus, the sufficient electric field is provided in the carbon nanotubes for a sufficient time to generate the energy gain either by restraining the carbon nanotubes from moving during the irradiation with the microwaves pulses and/or by configuring the incident microwave radiation such that it covers a sufficient area in which the radiation is able to generate a sufficient electric field in the nanotubes for the energy gain. The carbon nanotubes may be restrained by being placed in a container between microwave transparent packing material. The packing material keeps the nanotubes in place during the irradiation. The packing material and radiation configurations will be described in more detail below. The packing material may be in the simplest case just the mixture of catalyst materials and the catalyst support.

The material, such as carbon nanotubes, may be located in the region of catalyst materials and the chemical reactants, which can be present in a stationery way (batch reactor) or flowed over the catalyst with the products exiting as part of the overall flow (flow or pulse reactor). In some embodiments, the environment surrounding the region with the carbon nanotubes, or other selected energy transfer or production agent, exhibits a character which does not irreversibly degrade the critical properties of the nanotube while they are irradiated by microwave or other electromagnetic pulses. For example, the environment could have a non-oxidizing character while it is irradiated by microwave pulses. In this case, the material may be located in a high or low vacuum or an inert ambient, which can include nitrogen or an inert gas, such as argon or helium. The environment also may include a mixture of reactant and/or product chemicals which themselves do not react with the carbon nanotubes while they are irradiated by microwave pulses. The reactor chamber which holds the catalytic mixture and in which the catalyzed chemical processes take place may include a microwave transparent material which can include, but are not necessarily limited to, materials such as glass or other ceramics, for example.

In some embodiments, the carbon nanotubes may be physically combined with or in the mixture of catalysts and support materials or the carbon nanotubes themselves, at least in part, can act directly as the support materials. In the latter case, teachings of some embodiments recognize the capability to provide instantaneous heating and energy flow during the activation of the nanotubes by the microwave irradiation because the catalyst particles or objects can be attached directly to the nanotubes.

An example of how a catalyst particle may be directly bound to a carbon nanotube has been given by the work of Hee Cheul Choi, Moonsub Shim, Sarunya Bangsaruntip, and Hongjie Dai (Journal of The American Chemical Society, 2002,124(31); 9058-9059). This reference shows that Pt and Au nanoparticles can be caused to form spontaneously onto carbon nanotubes by appropriate immersion of the nanotubes into salt solutions of the metal ions. FIG. 2 shows an image of such metal particle decorated nanotubes, taken from the work of Choi et al, for the case of Pt particles.

In some embodiments, once under long wavelength irradiation, the carbon nanotubes, or other selected energy transfer or production objects, are caused to emit thermal energy (i.e., heat), as well as other forms of energy in some cases as determined by the initial states of the nanotubes and the radiation conditions. Other forms of energy can include, but are not necessarily limited to, visible, infrared and ultraviolet radiation. It may be desirable for a given purpose in a catalytic process that the magnitude of the thermal energy emitted by the material is greater than the magnitude of the energy of the microwave radiation. For example, the magnitude of the thermal energy emitted by the material may be at least 10 times greater than the magnitude of the energy of the microwave radiation. Or it may be that the magnitude of the thermal energy emitted by the material is 10 to 100 or even 1000 times greater than the magnitude of the energy of the microwave radiation.

Once under long wavelength irradiation, the amount of emitted energy delivered from the carbon nanotubes to the catalytic mixture over any interval of time may be controlled by the irradiation power, the wavelength, or mixtures of different wavelengths from different irradiation sources, the geometry of the irradiation sources relative to the catalytic reactor and the length of an irradiation pulse, or any combination of any number of these parameters.

In some embodiments, irradiating the material, such as carbon nanotubes, with microwave radiation also generates a plasma about the nanotubes. The plasma may include ions of elements that are found in and/or on nanotubes, such as carbon ions as well as impurity ions that may be present in the nanotubes, such as oxygen, hydrogen, iron, nitrogen and/or silicon ions. The plasma may be used to advantage in causing the catalytic process to be directed towards a desired product with a desired change in the process efficiency. Process efficiency may be defined as speed, reactions not otherwise possible, or higher yield of resulting molecules than otherwise possible.

Any suitable microwave emitting device may be used. For example, a magnetron, a klystron or a backward wave oscillator microwave emitting device may be used. If a magnetron microwave source is used, then a microwave emitter, such as an antenna, of the magnetron is positioned as close as possible to the carbon nanotubes. In some exemplary embodiments, the emitter is positioned 4 mm or less from the nanotubes in a near field configuration to deliver an electric field of at least 10,000 V/cm in the nanotubes.

### Example Process Parameters

Without wishing to be bound by a particular theory, teachings of certain embodiments recognize that, by controlling some or all of the process parameters described herein, one may obtain an energy gain or release from the material being irradiated with long wavelength radiation. In one example, the material acts as an energy production source. These parameters include the electric field component of microwave radiation, size of the nanoscale size space in the material (such as the inner diameter of carbon nanotubes), and absence of oxygen. Other parameters include the density of carbon nanotubes, the purity of carbon nanotubes, the generation of the plasma and physical stability of the sample in the microwaves. This list of parameters is not exhaustive, and other parameters may or may not affect results such as energy gain or release.

If some of the process parameters are not provided, teachings of certain embodiments recognize that less thermal energy may be released from the material than microwave energy has been put into the material. In other words, a certain number of joules of microwave energy may be supplied and a lower number of joules of thermal energy may be released. In this example, the material acts as an energy transfer agent. Whatever measure of thermal energy obtained from the material may provide a very efficient method of converting microwave energy to thermal energy.

REACTOR AMBIENT. The first process parameter that may be controlled for energy gain is the ambient. For carbon nanotube material, the absence of oxygen contributes to the energy gain. If oxygen is present, then purified and unpurified nanotubes may rapidly oxidize or burn (i.e., will be destroyed). For example, unpurified nanotubes exposed to microwave fields in air may result in two substances, one of which will be orange in appearance, and the other will be black. It is believed that the orange substance will be hematite, or iron oxide, such as from the catalyst used to prepare the nanotubes, and that the black substance will be highly purified nanotubes, which will lack the extra carbon material and iron catalyst. However, if the nanotubes are maintained in a non-oxidizing ambient, such as in a vacuum, an inert ambient, such as argon, helium or nitrogen, or in a reducing ambient, such as in hydrogen or forming gas, or in a reaction mixture which undergoes reactions with causing oxidation or other deleterious effects to carbon, then the irreversible chemical degradation of the nanotubes can be avoided. The nanotubes remain intact and release thermal energy in amounts dictated by the applied conditions of irradiation and the initial state of the nanotubes.

In some embodiments, the delivery of energy into the catalytic reaction region of a reactor will allow raising of the temperature of the catalytic materials to a value that is optimal for the desired chemical conversion for the specified time of a process step. The temperature thusly may be changed occasionally or even repeatedly as needed for optimum catalytic reactions. The delivery of energy for this purpose is specific and immediate to the catalytic materials and does not require heating of the reactor container itself or its external surroundings such as supports, pipes or other required structural functions which themselves do not contribute directly to the catalytic process, which thus may result in an overall increase in the thermal efficiency for the entire process apparatus. The appropriate types of carbon nanotubes may have cross sections for absorption and conversion of the long wavelength radiation to emitted energy that can be far greater than the cross sections for a variety of common materials including, but not limited to, metals, ceramics, organic chemicals, and plastics. Thus, under long wavelength irradiation, the energy emission of the carbon nanotubes can dominate any thermal contributions to the reaction region in comparison to that from direct heating of any of the chemical components of any reactant or product mixture, the catalyst and/or the catalyst support materials, and the reactor itself or any of its structural components, including valves, pipes and supports should they be In the field of the irradiation. In this way, the long wavelength irradiation of the carbon nanotubes may assume the role of controlling the temperature of the catalytic materials in the vicinity of the carbon nanotubes and become essentially the exclusive agent for changing the thermal conditions of the reactions. The speed with which such changes can occur in terms of cycling the reaction temperature during the processing cycles may depend upon the thermal mass (heat capacity) of the catalytic reaction materials and the thermal transport rate therefrom to the reactor walls and the flow of reactant and/or inert materials past the catalytic materials. A fast flow of heat away from the catalytic materials to the surroundings may result in higher energy input or longer irradiation times required during the irradiation period to reach a given temperature and conversely for a cooling cycle a longer time for cooling to the desired temperature. In some embodiments, these conditions may be optimized by engineering the reactor and process design so that any desired temperature cycle may be achieved.

ELECTRIC FIELD. The second process parameter that may be controlled is that the electric field in the material being irradiated with the microwaves should be above a certain threshold value. The threshold value may vary for different materials and may also vary based on the other process parameters. An example threshold value of the electric field is about 10,000 V/cm. However, the threshold value may be higher for some process parameter combinations, such as between 11,000 and 15,000 V/cm, for example, or lower for other parameters, such as between 700 and 9,000 V/cm. For example, for irradiation with high power microwaves, such as microwaves having a power of 2 kW, it is believed that an electric field of only 667 V/cm may produce an energy gain of about one (i.e., the input energy is about the same as the output energy). Thus, for 2 kW microwave power, an electric field of greater than 700 V/cm is expected to generate an energy gain of greater than one. In general, for high microwave power of several thousand Watts, such as 2 kW or greater, an electric field of several hundred to a few thousand V/cm may generate an energy gain of greater than one. In contrast, for low microwave power, such as 1 kW or lower microwave power, an electric field of several thousand Vlcm, such as at least 14,000 Vlcm may generate an energy gain of greater than one.

In some embodiments, the electric field of the microwaves should be higher than that in a home microwave oven due to a typical difference in source to sample distance. In a home microwave oven, the object exposed to the microwave field is in a far field configuration. This is an area of the field in which the electric and magnetic components of the field are completely coupled and the field is fully formed. In some embodiments, for magnetron type microwave source, the material being irradiated with microwaves may be in a near field with respect to the microwave emitter, such as when the material is located within 4 mm from the emitter. In the near field, a large electric component of the field is present due to the field or wave not being completely formed. Furthermore, the electric and magnetic components are essentially independent entities due to the lack of a poynting vector in the near field. In the case of the near field, the electric field can reach 10,000 Volts per centimeter and above.

The high electric field can also be obtained by using various resonant devices such as a waveguide or resonant cavity rather than using a near field configuration. In this example, the resonant devices take in a microwave from a suitable microwave source, such as a microwave magnetron, klystron, backward wave oscillator or some other device. The resonant devices then separate the microwave into its component electric and magnetic parts and either cause that wave to travel down the waveguide or be in some resonant condition in a cavity device. In such resonant devices, the electric and magnetic components may be at a maximum and in theory can become very high. In practice, it is believed that the highest observed electric field to date is about 1.2 million Volts per centimeter. The resonant devices can be used to expose the carbon nanotubes to microwaves having very high electric field values and thereby causing an increase in the energy gain.

PLASMA. It is believed that when carbon nanotubes are exposed to microwaves having a high electric field value in a non-oxidizing ambient, then a bright plasma may ignite. The specific examples illustrate that the thermal energy release is more efficient with the presence of the plasma. In contrast, if no plasma is formed, then thermal energy release may still be seen but its efficiency may be much lower and the excess energy gain or release may be absent. When the electric field is below 5000 V/cm, it is believed that no plasma may be formed.

The plasma's spectra exhibits plasma lines from any element or impurity in the nanotube sample. For instance, most nanotube samples contain carbon, hydrogen, nitrogen, iron, etc. Thus, ionized states of each of these elements may be observed, with the plasma lines being more ionized with a decrease in the diameter nanotubes or an increase in the electric field. Without wishing to be bound by a particular theory, it is believed that these two factors lead to a higher surface charge density on the nanotubes (i.e., due to the smaller surface area of narrower nanotubes) which may in turn lead to a higher ionized plasma state. The ionized state of the plasma may be controlled by controlling the nanotube dimensions and purity. For example, a higher ionized state may be obtained by decreasing the nanotube diameter and/or length. Furthermore, the particular ion species in the plasma may be provided by providing or doping the species into or onto the nanotubes.

Furthermore, without wishing to be bound by a specific theory, it is believed that an electron plasma may also be formed. It is believed that the ion and/or the electron plasma does not necessarily have the same pulse frequency as the pulse frequency of the pulsed microwave source. Thus, a continuous plasma or a plasma that has a different frequency than that of the microwave source may be generated. Thus, the nanotubes may exhibit a capacitive effect with regards to plasma generation because the microwave pulse frequency may be decoupled from the plasma frequency. Without wishing to be bound by a specific theory, it is believed that the nanotubes act as an initial energy pathway between the microwave energy and the plasma. It is possible that the ion plasma may be maintained in the presence of the microwaves even after the nanotubes are removed.

The ability to cause or not cause a plasma during long wavelength irradiation can be used to advantage to provide a particular type of environment that may be useful in causing certain types of desired outcomes of any catalytic chemical reaction process in the reactor. For example, on one hand, the reactants may consist of harmful chemicals that can be converted to harmless products by means of the energetic conditions of a plasma. On the other hand, the reactants may consist of simple feedstocks that can be converted to desired products achieved or accelerated by means of the energetic conditions of the plasma. Such products, for example, could even consist of the production of carbon nanotubes themselves if the reactor contains the proper catalyst materials, such as, but not necessarily limited to, transition metals, and if the feedstocks were to contain carbon atoms.

NANOTUBE DIAMETER. It is believed that the nanotube diameter is inversely proportional to the energy gain (i.e., excess thermal energy release). Thus, as the inner diameter of the single walled or multi-walled nanotubes is decreased, the thermal output may be increased. In some embodiments, the inner diameter of the nanotubes is 1.1 nm or less, such as 0.7 to 1.1 nm. Slightly larger diameter nanotubes may also be used if the other process conditions are optimized. When the nanotubes are housed in a glass container, for a decreasing nanotube inner diameter, a larger amount of glass melts for a predetermined amount of microwave irradiation time or the same amount of glass melts but in a much shorter time. SWNTs may provide more efficient energy gain than MWNTs with very small inner diameters. Without wishing to be bound by a particular theory, it is believed that this effect is due to the overall number of narrower diameter tubes in a sample of single walled material being much higher than in a sample of multiwalled nanotubes of similar mass.

NANOTUBE DENSITY. The energy gain may also increase with increasing nanotube density and purity. For example, BuckyPearl® brand HiPCo type of nanotubes are about 40 times denser than conventional single wall nanotubes. The use of this brand of nanotubes results in very intense plasmas consisting of more highly ionized states than plasmas generated with the less dense nanotubes of a similar diameter. This increase in density may also cause a more energetic reaction to be seen (i.e. more glass will melt in a smaller period of time). Without wishing to be bound by any particular theory, the increase in thermal energy gain or release with increasing nanotube density may be due to an exchange of phonons from one nanotube to another in a more efficient manner and/or due to a more efficient interaction of overlapping EMF generated by the nanotubes to conduct a current that they pick up from the microwave field.

NANOTUBE PURITY. Furthermore, a higher energy gain may result from increasing nanotube purity. Without wishing to be bound by any particular theory, the increase may be due to decreased amount of amorphous carbon which does not provide an energy gain in the purified samples.

SAMPLE STABILITY. The physical stability of the nanotubes may be important to the thermal transfer or production to the extent that the nanotubes are maintained in the sufficient electric field of the microwaves for a sufficient amount of time. The stability may be achieved by any suitable method that keeps the nanotubes from flying around inside their container during microwave irradiation. If the nanotubes are not kept still, upon application of the microwave field, the nanotubes may fly out of the field. If the microwaves are applied to the nanotube sample in such a way as to maintain the high electric field in moving nanotubes, then the nanotubes do not have to be fixed or kept still. Therefore either fixing the nanotubes in one location or spreading the high electric field over the area where the nanotubes can become mobile can be used to generate the energy gain.

### Example

The following section presents various findings from a number of experiments. The teachings described herein may or may not be limited to the scope of the described experiments and do not necessarily apply to embodiments outside the scope of the described experiments.

In a number of independent experiments, milligram quantities of nanotubes were exposed to continuous microwave fluxes for several seconds of irradiation and produced a blinding light emission, comparable in intensity to a welding arc. Many of these experiments were repeat runs which produced very similar results. Some experiments, as detailed below, produced an energy gain of at least a factor of ten in the form of thermal energy emission form the SWNTs.

The SWNTs are observed to retain their overall structural integrity after irradiation and thus are not consumed by chemical reactions. However, after a certain duration of irradiation, a sufficient percent of the nanotubes in the sample experienced diameter doubling and/or a chirality change which led to termination of the energy gain and/or of the energy transfer (though not necessarily at the same time) when a majority of the nanotubes experienced this change. Furthermore, in some experiments the tube containing the nanotubes was broken which lead to oxidation of the nanotubes and termination of the energy gain and light emission.

A variety of nanotubes of different purification levels and diameters were used from different sources: 1.5 nm average diameter, purified SWNTs (laser oven purified SWNTs from Carbolex Inc., Lexington, Ky. and other custom made SWNTs); 1.5 and 1.1 nm average diameter, raw and purified SWNTs made by the HiPCo process (CNI, Houston, Tex.); 2-20 nm diameter×5-20 Rm length muitiwall nanotubes (MWNTs from Sigma Aldrich); and 0.9 nm average inner diameter double walled MWNTs from Rossetter Holdings. The energy gain was only observed for the dense BuckyPearl® 1.1 nm HiPCo SWNT samples and the Rossetter Holdings MWNT samples. A small quantity of 0.7 and 1.3 nm SWNTs from NEC were also used in a very limited number of experiments. However, the amount of NEC SWNTs that were obtained were not sufficient to conduct a sufficient number of repeatable experiments.

The microwaves were generated using a number of magnetrons, such as Goldstar° model 2M223 magnetrons operating at a frequency of 2.45 GHz (12.2 cm wavelength) radiating into free space. Different power magnetrons were used, such as about 300 watt, about 450 watts and about 1000 watts. The typical output power measured for a new 450 watt magnetron was about 420 to 450 watts. Some magnetrons were subsequently internally modified by inducing a slight shorting condition in the tube such that the output power was about 50 watts.

The maximum microwave power output of each modified magnetron in the absence of SWNT samples was calibrated by thermal calorimetry using the heating of a water medium and/or current-voltage (I-V) monitoring of the magnetron unit. Both methods give agreement within the errors of the measurements (typically ±2-3%). In addition, cross checks on the maximum radiation power possible were done by monitoring the (I-V) characteristics of the line voltage during operation.

In each experiment, a weighed amount of a SWNT sample ranging from 5 to 500 mg was placed in a laboratory tube. Most runs used about 25 mg of nanotubes. The tubes in most experiments were closed end, clear tubes of about 4 mm inner diameter, about 6 mm outer diameter and having a length of about 15 cm. The tubes were believed to be made of quartz, but could have been made of a similar clear glass type substance, such as Pyrex. In most experiments, the tubes were sequentially connected to a stainless steel vacuum system though a glass to metal seal. A valve was situated between the sample and the main chamber, which was pumped to a pressure lower than 10-8 Torr with the sample valve open. Pressures as high as about 10-3 Torr, however, did not result in significant differences in the experimental results.

In a large number of the experimental runs, the nanotubes were packed in a thermal absorbing packing material to fix the nanotubes to a predetermined location in the tubes because the nanotubes without the packing material tend to fly around the container. Specifically, crushed SiO₂ was placed in the bottom of the tubes, the nanotubes were placed on top of the crushed SiO₂ and then additional crushed SiO₂ was placed on top of the nanotubes. 1 to 50 grams of crushed SiO2 was placed below and above the nanotubes. In most runs, 1 gram of SiO₂ was used with 4 mm diameter tubes. Larger amounts of SiO₂ were used for runs conducted in larger diameter tubes. However, the increase in tube diameter increases the likelihood that the nanotubes will move around the tube during irradiation. For a 30 gram SiO₂ experimental run, the SiO₂ extends about 1 cm above and below the nanotubes in the tube. Crushed quartz is preferred to silica powder as the crushed SiO₂ since silica powder tends to be thrown around the vacuum system. Other microwave transparent materials, such as alumina, can also be used as a packing material. A ceramic spacer was placed on the bottom of the tubes for two experiments, but was found not to provide any appreciable benefit and was not used in the remainder of the experiments.

The sample tubes were sequentially placed in the near-field region at a distance of 1-4 mm from the front surface of the magnetron (i.e., from the emitter of the magnetron). The long edge of the tubes was placed running at about a 5 to 15 degree angle off parallel to the front face of the magnetron, with the edge of the tube containing the nanotubes located 1-4 mm from the front face of the magnetron. The angular positioning of the tubes is believed to be one way to increase the electric field generated in the nanotubes. A rectangular reflector with a cone angle of about 105 degrees was used in a number of runs to increase the electric field generated in the nanotubes.

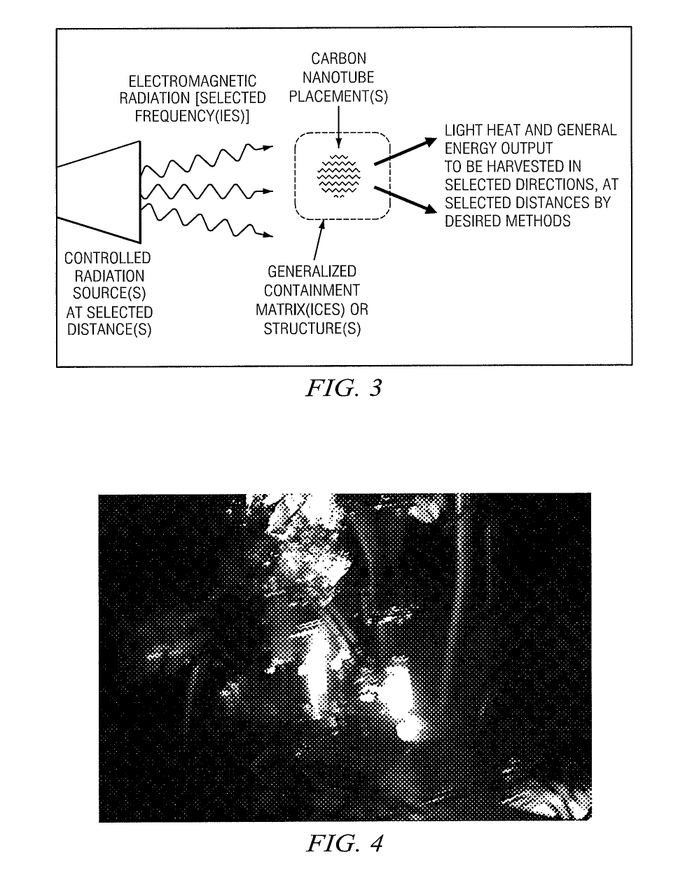

FIG. 3 schematically illustrates a generalized apparatus or any other implementation which can be configured to utilize the effects of electromagnetic irradiation of carbon nanotubes. The invention uses any general configuration in which any microwave, or, in general, electromagnetic radiation emitting source, is placed at any convenient distance from the carbon nanotubes contained in any way that allows the electromagnetic field to reach the carbon nanotubes. The output can include any form of released energy, including but not limited to light, heat and charged particles, that is harvested by any desired and appropriate means. In some embodiments, the important aspect, regardless of the wavelength of electromagnetic radiation used is that the electric field be at a maximum (in air this is 10,000 volts per meter approximately before air breaks down). The shape/size of the reflectors and placement of the source may be dependent upon the wavelength; however, any suitable method for determination of these parameters may be used.

Light emission from the nanotubes was detected using an optical fiber with a focusing lens placed about 5 cm from the sample. The fiber was connected to an optical spectrometer (Ocean Optics model USB 2000) operating over the range of 180-880 nm at 0.28 nm resolution with a minimum 10 ms full spectrum acquisition time.

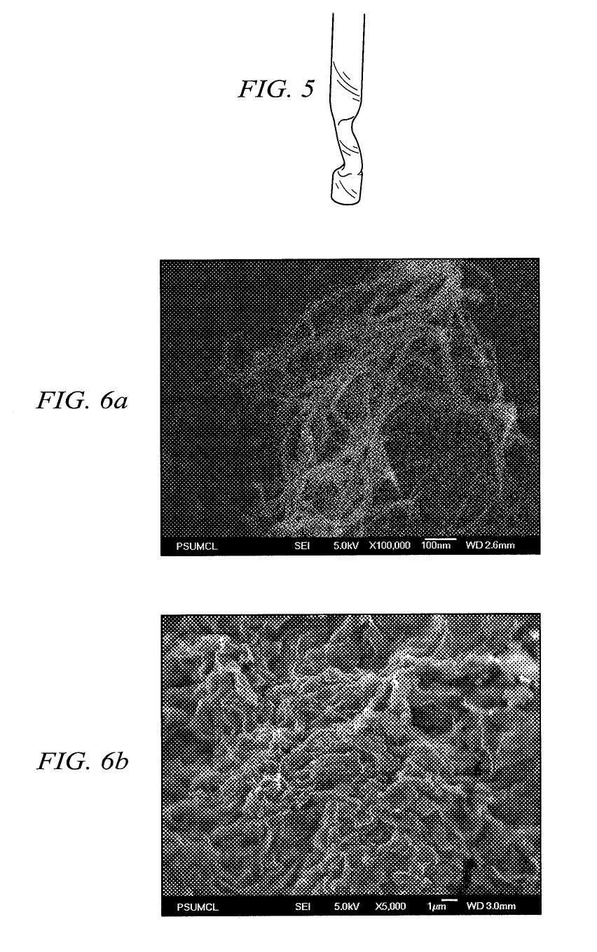

In every example which used SWNTs with average diameter of 1.1 nm or smaller, regardless of the synthesis method, source of material or purity level, a brilliant light, similar to a welding arc, was emitted from the sample upon the start of microwave irradiation, continued for 3-5 s, in some cases up to 15-20 s, and typically ended abruptly (usually due to the melting of the glass or quartz tube), as shown in FIG. 4. It should be noted that the quality of the tubes varies. Thus, there was a difference in how long it took a particular tube to melt (i.e., 5 seconds or less to 15 seconds or more depending on the quality of the tube). Examination immediately after the termination of the emission in experiments with an energy gain and in some experiments without an energy gain showed that local melting of the tube holding the sample had occurred in the vicinity of the SWNT sample, as shown in FIG. 5. Thus, the melting of the tube and the exposure of the nanotubes to air could have been responsible for the termination of the light emission. Furthermore, the microwave irradiation causes any adsorbed or absorbed species on the microwaves, such as hydrogen atoms, to be desorbed or desorped from the nanotubes.

The brightness of the light emission was greatest for the smallest diameter, the highest purity and the most dense forms of the nanotubes, all other variables being constant for each experiment. In particular, for SWNT samples with average diameters of 1.5 nm, the light emission was very dim and produced only minor warming of the tube. MWNT samples with large inner diameter nanotubes similarly showed only a minor temperature rise but in this case the only light emission was a barely detectable output in the near IR region. Control experiments with purified graphite powder, standard carbon particles and inert dielectric substances such as powdered SiO₂ showed no effects whatsoever, with even minutes of irradiation, resulting in only the expected slight warming of the sample.

Visual examination of post-irradiation samples heated in vacuum typically showed the samples remained as a black material, even for runs with extremely bright light emission and heating. In the case of 1.1 nm SWNNs, for which intense heating and light emission had occurred, removal of the samples, which required breaking the surrounding melted quartz, and reloading into a vacuum system followed by microwave irradiation resulted in some light emission activity, though reduced in intensity from the original irradiation event.

Several 1.1 nm SWNT samples were characterized by scanning and transmission electron microscopy (SEM and TEM) and by Raman spectroscopy after being irradiated with microwaves. The results of the microscopy examination showed that after microwave exposure, these samples still consisted of nanotubes, although with some subtle variations in the physical structures. FIGS. 6A and 6B show SEM images of a 1.1 nm average diameter SWNT sample before (FIG. 6A) and after (FIG. 6B) 6 second irradiation of 2.45 GHz microwaves from a magnetron source having the above described reflector and operating with a 50 W total output power. The samples were about 25 mg BuckyPearl® HiPCo SWNT samples packed with about 1 gram of crushed quartz. The microwave emitter was positioned about 1 to 4 mm from the nanotubes at an angle of about 5 to 15 degrees. The image clearly shows the presence of nanotube ropes after the irradiation process. During this irradiation, brilliant light emission and intense heating were observed. The length scale shown is the same for both images. The nanotubes tend to fuse or weld to adjacent nanotubes and to form looped structures after being irradiated with microwaves. Furthermore, the nanotubes tend to expand from their original volume during the microwave irradiation and then contract to a volume that is about the same or greater than the original volume after the irradiation is completed. Still further, in a sample of mixed metallic and semiconducting SWNTs, a chirality shift is observed. The metallic SWNTs in the sample are restructured into mostly semiconducting SWNTs between about 4 and 7 seconds of irradiation (peaking at about 6 seconds of microwave irradiation) and then revert back to mostly metallic SWNTs after more than 7 seconds, such as 20 seconds of microwave irradiation. Without wishing to be bound by a particular theory, it is believed that the chirality shift may occur due to a partially completed coalescence of the nanotubes which leads to diameter increase, such as diameter doubling, of the nanotubes during irradiation.

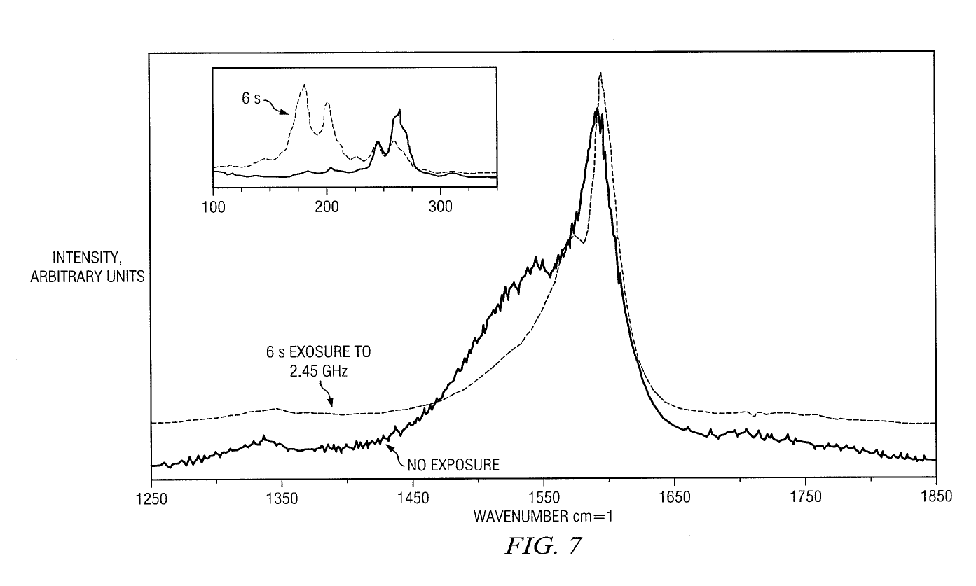

FIG. 7 shows the typical Raman spectra (514.5 nm excitation) of single wall nanotubes before and after 6 second microwave irradiation. Both spectra show a main, intense asymmetric peak at about 1592 cm⁻¹ (presumed to be E₁₅, E_{2g}, A_{1g}, C-C stretching modes) and a weak peak at about 1340 cm⁻¹ (presumed to be a disorder or defect peak), which are uniquely distinctive for the nanotube form of carbon. FIG. 7 also shows sharp features in the 140-200 cm⁻¹ region (presumed to be A_{1g}. breathing modes), which are indicative of a transformation of diameters of nanotubes to larger diameters. FIG. 7 shows the 1250 to 1850 cm⁻¹ Raman spectra for SWNTs irradiated for 0, 6 and 20 seconds. The nanotube peak for the sample irradiated for 20 seconds is in about the same position as the peak for the sample that was not irradiated. However, the nanotube peak for the sample irradiated for 6 seconds shifted to a higher wavenumber. The height of the detect peak also increased with increasing irradiation time. Far samples that have been irradiated for minutes, the diameters of the nanotubes double and then double again.

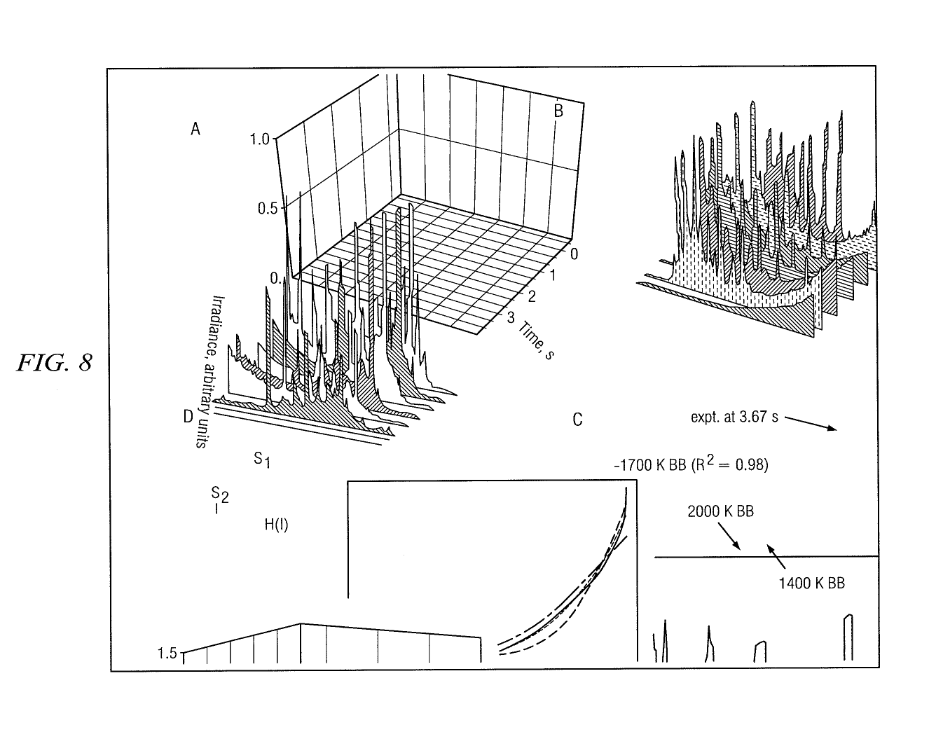

An example of the microwave irradiated SWNT light emission spectra is shown in FIG. 8. This Figure shows a time averaged spectrum of a 1.1 nm average diameter, purified SWNT sample exposed to a 2.45 GHz magnetron source measured to have a 50 (±3) W total output power with no sample. The sample was an about 25 mg BuckyPearl® HiPCo SWNT sample packed with about 1 gram of crushed quartz. The microwave emitter was positioned about 1 to 4 mm from the nanotubes at an angle of about 5 to 15 degrees. The spectrum integration was done over a 100 ms acquisition starting after 2 seconds of magnetron on time to ensure the attainment of a pulsed microwave flux. The sharp peaks are assigned to diagnostic optical transitions for elements, such as C, H and Fe, present in the nanotube sample, as indicated for C and H. As light emission progresses, the H line intensity consistently decreases rapidly, indicating outgassing of hydrogen impurity, which is confirmed by parallel quadruple mass spectrometer measurements. Despite extensive examination, no oxygen spectra were found, consistent with the absence of combustion. The inset shows the envelope of the broad spectral feature stretching from about 400 to 700 nm. The estimated peak of this curve is at about 480 nm, as marked by the arrow.

The presence of line spectra indicates the presence of a charged plasma within the region of the nanotube sample. The broad intensity envelope under the line features is reminiscent of a blackbody curve and shows a maximum in the about 500 nm region. During the course of any of the above described experiments, the peak typically shifted. For example, in FIG. 8, the peak shifted from about 535 to 477 nm and the peak shown in the inset appears at about 480 nm. This is typical of non-equilibrium systems such as this.

A parallel experiment shows an estimated blackbody temperature versus total irradiation time. This shows the time evolution of average system temperatures over a parallel run as calculated from the envelope maximum frequency with Wien's law of black body radiation. The temperatures were calculated from the spectral data by assigning all the atomic transitions, subtracting curve-fitted line spectra for each of these transitions from the overall curve to leave a broad, nearly featureless envelope, assigning the maximum of the resulting broad envelope, and applying Wien's law, T=0.0029/λₘₐₓ. The correlation between the peak maxima and temperatures were verified by calibration using a NIST traceable light source as shown in FIG. 8. The longest time point shown occurred just prior to the cessation of the light emission for this sample. The estimated total errors in the temperature values are about +/−5%.

The average temperature in the parallel experiment stays between about 5400 to about 6000 K_ In view of the theoretically estimated 4×10³ K disintegration temperature threshold for carbon nanotubes, the ability of the nanotubes to maintain significantly higher electron plasma temperatures without disintegration suggests extensive decoupling of the phonon and electron plasma excitation manifolds. The presence of gamma and X-ray emission was checked using calibrated Nal detectors. No emission was observed above normal background radiation in the 4-70 keV and 70 KeV-8 MeV regions, with an upper limit of ˜2×10⁵ counts set for gamma rays at 2 MeV.

ENERGY GAIN CALCULATIONS. Quantitative lower limit measurements of the thermal heat output were done in a series of experiments with crushed quartz surrounding the SWNT samples. In each experiment, in addition to typical bright light emission and accompanying local melting of the containment tube, the added SiO2 was visually observed to have fully melted.

A typical thermal balance is illustrated in an experiment in which about 1 g of crushed quartz surrounding the 1.1 nm diameter SuckyPearl® SWNTs was exposed to an about 3 second microwave flux from a magnetron with a calibrated total output power of 50 (±3) Watts. The microwave source was positioned about 1 mm away from the tube containing the SWNTs. Postirradiation examination clearly showed the added SiO₂ had fully fused, along with some local melting of the containment tube. The melted portion of the tube was cut away and weighted. The weight of this portion of the tube was about 0.3 grams. Thus, a total of 1.3 grams (0.022 mol) of SiO₂ was melted (1 gram from the crushed quartz and 0.3 grams from the tube). 10 repeat runs all gave substantially identical results. Given the melting point for SiO₂ of about 2000 K, the energy required to bring the SiO₂ from ambient temperature to just below the melting point (about 1900 K) at constant pressure is given by the standard enthalpy difference H° (1900)-H° (298)=111.5 kJ/mol. Adding the fusion enthalpy of 9.6 kJ/mol gives a minimum of about 2.6 kJ required to melt the 0.022 mol of SiO₂. Heating to higher temperatures would only increase the enthalpy demand. The maximum amount of energy that possibly could be delivered from the microwave source to the sample would be Pₜₒₜₐₗ*t, where Pₜₒₜₐₗ=the calibrated total magnetron power output, which is about 50 J/s in this case, and t=total irradiation time. Setting t=5 seconds (conservatively including the 2 second warm up time before maximum flux), a conservative estimate of Pₜₒₜₐₗ is about 0.25 kJ. Thus, the ratio of the minimum energy required to heat and melt the SiO₂ to the maximum possible microwave energy delivered to the sample represents a very conservative energy gain factor of about (2.6 (kJ)/(0.25 kJ)=10.4. A cross check on the heat content of the glowing tube was estimated calorimetrically by accurately measuring the temperature change after plunging the vessel into a weighed quantity of water (thermal balance connected for evaporative losses) gave a value of 2.1-kJ, about 80% of above number.

The tables below illustrates the results of various experiments in which 50, 300 or 1000 watt microwave sources irradiated a sample having about 25 mg SWNTs packed in 1 gram of crushed quartz, and located in vacuum, with 1-4 mm emitter to nanotube distance and 5 to 15 degree emitter angle used with the reflector described above. It is believed that an electric field of at least 10,000 Vlcm was generated in the nanotubes by the microwave irradiation. The SWNT samples were either 1.5 nm diameter custom made SWNTs or 1.1 nm diameter BuckyPearl® SWNTs. The irradiation duration was either 5 or 15 seconds. The thermal energy release for the experimental runs with the 1.1 nm samples was estimated using the above described method. The thermal energy release for the experimental runs with the 1.5 nm samples was estimated using a water dunk calorimetery test.

Table 2, below, shows the results for 50 W microwave irradiation for 5 seconds for custom made 1.5 nm diameter SWNTs (comparative examples 1-5) and 1.1 nm BuckyPearl® SWNTs (examples 1-5). It should be rioted that the term “comparative examples” as used herein does not mean “prior art examples” and should not be considered to be an admission that the subject matter of the comparative examples is found in the prior art. Instead, comparative examples are examples in which no energy gain was observed. However, the subject matter of the comparative examples may still be part of certain embodiments.

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C1 | 250 Joules | 220 Joules |
| C2 | 250 Joules | 210 Joules |
| C3 | 250 Joules | 250 Joules |
| C4 | 250 Joules | 140 Joules |
| C5 | 250 Joules | 200 Joules |

1.1 nm nanotubes

| | | |
|---|---|---|
| 1 | 250 Joules | 2610 Joules |
| 2 | 250 Joules | 2700 Joules |
| 3 | 250 Joules | 2630 Joules |
| 4 | 250 Joules | 2540 Joules |
| 5 | 250 Joules | 2580 Joules |

Table 3, below, shows the results for 300 W microwave irradiation for 5 seconds for custom made 1.5 nm diameter SWNTs (comparative examples 610) and 1.1 nm BuckyPearl® SWNTs (examples 6-10).

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C6 | 1500 Joules | 1110 Joules |
| C7 | 1500 Joules | 1220 Joules |
| C8 | 1500 Joules | 1210 Joules |
| C9 | 1500 Joules | 1260 Joules |
| C10 | 1500 Joules | 1310 Joules |

1.1 nm nanotubes

| | | |
|---|---|---|
| 6 | 1500 Joules | 6010 Joules |
| 7 | 1500 Joules | 6040 Joules |
| 8 | 1500 Joules | 5910 Joules |
| 9 | 1500 Joules | 6080 Joules |
| 10 | 1500 Joules | 6020 Joules |

Table 4, below, shows the results for 1000 W microwave irradiation for 5 seconds for custom made 1.5.nm diameter SWNTs (comparative examples 11-15) and 1.1 nm BuckyPearl® SWNTs (examples 11-15).

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C11 | 5000 Joules | 1270 Joules |
| C12 | 5000 Joules | 1160 Joules |
| C13 | 5000 Joules | 1220 Joules |
| C14 | 5000 Joules | 1200 Joules |
| C15 | 5000 Joules | 1220 Joules |

1.1 nm nanotubes

| | | |
|---|---|---|
| 11 | 5000 Joules | 5980 Joules |
| 12 | 5000 Joules | 6030 Joules |
| 13 | 5000 Joules | 6010 Joules |
| 14 | 5000 Joules | 6040 Joules |
| 15 | 5000 Joules | 5990 Joules |

Table 5, below, shows the results for 50 W microwave irradiation for 15 seconds for custom made 1_{—}5 nm diameter SWNTs (comparative examples 16-20) and 1.1 nm BuckyPearl® SWNTs (examples 16-20).

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C16 | 750 Joules | 470 Joules |
| C17 | 750 Joules | 500 Joules |
| C18 | 750 Joules | 510 Joules |
| C19 | 750 Joules | 510 Joules |
| C20 | 750 Joules | 490 Joules |

1.1 nm nanotubes

| | | |
|---|---|---|
| 16 | 750 Joules | 6900 Joules |
| 17 | 750 Joules | 6920 Joules |
| 18 | 750 Joules | 7080 Joules |
| 19 | 750 Joules | 7140 Joules |
| 20 | 750 Joules | 7010 Joules |

Table 6, below, shows the results for 300 W microwave irradiation for 15 seconds for custom made 1.5 nm diameter SWNTs (comparative examples 21-25) and 1.1 nm BuckyPearl® SW NTs (examples 21-25).

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C21 | 4500 Joules | 2790 Joules |
| C22 | 4500 Joules | 2830 Joules |
| C23 | 4500 Joules | 2750 Joules |
| C24 | 4500 Joules | 2840 Joules |
| C25 | 4500 Joules | 2810 Joules |

1.1 nm nanotubes

| | | |
|---|---|---|
| 21 | 4500 Joules | 8470 Joules |
| 22 | 4500 Joules | 8590 Joules |
| 23 | 4500 Joules | 8410 Joules |
| 24 | 4500 Joules | 8440 Joules |
| 25 | 4500 Joules | 8570 Joules |

Table 7, below, shows the results for 1,000 W microwave irradiation for 15 seconds for custom made 1.5 nm diameter SWNTs (comparative examples 26-30) and 1.1 nm BuckyPearl® SWNTs (examples 26-30).

| | | |
|---|---|---|
| EXAMPLE | AMOUNT OF MICRO- | AMOUNT OF THERMAL |
| NUMBER | WAVE ENERGY IN | ENERGY RELEASE |

1.5 nm nanotubes

| | | |
|---|---|---|
| C26 | 15,000 Joules | 2620 Joules |
| C27 | 15,000 Joules | 2760 Joules |
| C28 | 15,000 Joules | 2780 Joules |
| C29 | 15,000 Joules | 2690 Joules |
| C30 | 15,000 Joules | 2610 Joules. |

1.1 nm nanotubes

| | | |
|---|---|---|
| 26 | 15,000 Joules | 9180 Joules |
| 27 | 15,000 Joules | 9270 Joules |
| 28 | 15*000 Joules | 9240 Joules |
| 29. | 15,000 Joules | 9200 Joules |
| 30 | 15,000 Joules | 9190 Joules |

In the experiments of examples 1-30 it is believed that single and/or doubly ionized plasma as well as some higher states was generated. It is believed that temperatures of about 5500 K to about 6500 K were obtained. Furthermore, the experiment of examples 1-5 were repeated with different non-oxidizing ambients. In five of the runs, the vacuum ambient was replaced with a helium ambient. In another five of the runs, the vacuum ambient was replaced with an argon ambient. It is believed that the results obtained in the inert gas ambients were substantially the same to the results of the five experiments (examples 1-5) performed in a vacuum ambient. Thus, it appears that any non-oxidizing ambient may be used to generate the plasma and/or the energy gain.

Table 8, below, summarizes the results of comparative examples 1-30 for 1.5 nm nanotube samples.

| | | Energy of | Thermal |
|---|---|---|---|
| Microwave | Duration of | microwave | energy released |
| power (in | exposure (in | radiation (in | from nanotubes (in |
| Watts) | seconds) | Joules) | Joules, +/−100 J) |
| 50 | 5 | 250 | 200 |
| 300 | 5 | 1500 | 1200 |
| 1000 | 5 | 5000 | 1200 |
| 50 | 15. | 750 | 500 |
| 300 | 15 | 4500 | 2800 |
| 1000 | 15 | 15000 | 2700 |

Table 9, below, summarizes the results of examples 1-30 for 1.1 nm nanotube samples from tables 1-6.

| | | Energy of | Thermal |
|---|---|---|---|
| Microwave | Duration of | microwave | energy released |
| power (in | exposure (in | radiation (in | from nanotubes (in |
| Watts) | seconds) | Joules) | Joules, +/−100 J) |
| 50 | 5 | 250 | 2600 |
| 300 | 5 | 1500 | 6000 |
| 1000 | 5 | 5000 | 6000 |
| 50 | 15 | 750 | 7000 |
| 300 | 15 | 4500 | 8500 |
| 1000 | 15 | 15000 | 9200 |

It should be noted that from Table 9, it can be inferred that there may be an upper limit to the microwave energy as which an energy gain is observed. For example, the thermal energy output by the nanotubes for the 300 watt and 1000 watt microwave irradiation is very similar. For the 1000 watt irradiation for 15 seconds, the amount of energy put in was actually less than the amount of energy released. However, for shorter duration experiments (i.e., 5 second experiments) and for longer duration experiments (i.e., 15 second experiments) at lower microwave power (50 or 300 W), the amount of energy released is greater than the amount of energy put it. For the lowest energy experiments (50 W), the amount of energy released was at least about 10 times greater than the energy put it. However, as seen from Table 7, for large diameter nanotubes (1.5 nm for example), the amount of energy released was less then the amount of energy put in.

Additional comparative examples were performed by varying other parameters of experiments 1-30. In a first set of comparative examples, low density purified and unpurified SWNT samples (i.e., SWNTs having a density that is about 40 times lower than BuckyPearl® SWNTs) were exposed to about 420 W microwave irradiation in air. The unpurified SWNT samples which contained a large amount of amorphous carbon and amorphous iron catalyst material ignited and burned within a few seconds of being irradiated. After the completion of the irradiation, it was determined that the remainder of the burned material included hematite (FeO₃) and purified nanotubes (i.e., more purified that the starting nanotube sample). The purified samples containing a low amount of amorphous carbon and catalyst material did not bum, but instead displayed random scintillation of white light. No discernable changes were observed by electron microscopy and Raman spectroscopy in the purified samples after the microwave irradiation.

In a second set of comparative examples, the experiments of the first set of comparative examples were repeated in a vacuum ambient. The vacuum system was constructed from stainless steel with the nanotubes placed in a glass vessel or tube that was attached to the vacuum system through a glass to vacuum seal. The glass vessel was about 2 cm in diameter and several centimeters in length. There was no crushed quartz or powdered silica on top of the nanotubes. The nanotubes were merely placed in the bottom of the glass vacuum vessel. The magnetron was placed directly underneath the glass vacuum vessel approximately ⅔ wavelengths away (8 cm). It is believed that the magnetron in this configuration provided an electric field that is less than 10,000 V/cm in the nanotubes because the magnetron microwave source was not sufficiently close (i.e., farther than 4 mm away) from the nanotubes.

The unpurified nanotubes expanded in volume immediately upon application of the microwave field and then later contracted back to their original volume. During this time they emitted light. The purified single walled nanotubes of the original diameter produced light spectra very similar to that of unpurified nanotubes. Furthermore, hydrogen was desorbed from, the nanotube samples upon application of the microwave field. This experiment was repeated multiple times to show repeatability and reproducibility of the light spectra which repeated identically (within experimental error limitations) from run to run. However, no energy gain was observed at the low electric field configuration, although it was noted that the nanotubes would become very hot as a result of the application of the microwave field. Thus, even without an energy gain, nanotubes can rapidly and efficiently convert microwave energy to thermal energy. The nanotubes expanded and contracted repeatedly and flew about the vacuum vessel, which allowed some of them to escape the microwave field.

In a third set of comparative examples, the large vacuum vessel described above was replaced with a smaller one and small amount of SiO2 powder placed above the nanotubes to attempt to hold the nanotubes in place during microwave irradiation and to prevent the nanotubes from flying around the sample vessel or tube. The smaller vacuum vessel was a tube having a 4 mm inner and a 6 mm outer diameter. 25 mg plus or minus a very small mass (20) due to experimental error of 1.1 nm SWNTs was placed into the vacuum vessel. The samples had small amounts 25 mg of powdered SiO₂ on top of them. The vacuum level of at least 10⁻⁵ torr but not lower than 10⁻⁹ torr was used. This level of vacuum is more than sufficient to remove enough of the oxygen from the atmosphere that oxidation of the sample could not take place. Five of runs were performed with purified nanotubes and five were performed with unpurified nanotubes in the low electric field configuration.

However, the smaller diameter vacuum vessel and the small amount of SiO₂ powder were not sufficient to hold the nanotubes in place. The nanotubes were still blown around the vacuum system very quickly as the hydrogen in the samples was described, which was verified by a residual gas analyzer or RGA. It is believed that the narrow vacuum vessel did not allow expansion of the nanotube sample. Thus, the nanotubes became essentially micro thrusters—Thus, small amounts of nanotubes in this configuration can produce a small amount of thrust for airborne terrestrial and space vehicles, devices or payloads through release of stored gases. No energy gain was observed in the low electric field configuration.

In a fourth set of comparative examples, the amount of SiO₂ was increased. 1 gram of crushed Pyrex was used for a 25 mg SWNT sample. It was found that in some of the runs the nanotubes would remain stable and not move, but in other runs the nanotubes still moved around the vacuum system and out of the range of the microwave source. No energy gain was observed in the low electric field configuration even when the nanotubes remained in the microwave field and did not move about the vacuum vessel.

In a fifth set of comparative examples, the microwave source to sample distance was reduced to just about 0.5 mm plus the thickness of the glass. This is a higher electric field configuration for a magnetron microwave source. However, it is believed that the electric field induced in the nanotubes by the microwaves was less than 10,000 V/cm because the magnetron microwave source lacked a reflector which is adapted to increase the electric field induced by the magnetron to 10, {300 V/cm and above. Low density 1.1 nm SWNTs were used in five runs. In these runs, slightly faster (several tens of ms) desorption of gasses from the samples were observed than in the other comparative example. Furthermore, through post irradiation sample analysis, it was determined that in short exposure times (4-7 seconds) the majority of the nanotubes would take on a semiconducting form rather than a mixture of conductors and semiconductors. No energy gain was observed.

In a sixth set of comparative examples, the low density SWNTs were replaced with purified BuckyPearl® SWNTs which are approximately 40 times more dense than the nanotubes used in the other comparative examples. The blackbody temperatures started to elevate beyond the about 2000 to 3000 Kelvin to temperatures more closely approximating the surface of the sun and beyond (about 5500-6500 Kelvin). Furthermore, a plasma was observed in these runs. The plasma was singly ionized during most of the runs and reached a doubly ionized state near the end of the 25-35 second long runs. The plasma may reach higher ionized states with a higher electric field. A higher electric field may be obtained by any suitable microwave source adjustment, such as by placing a flat piece of metal that completely covers the reflector, except for an aperture (about ¼ wavelength in size) on the front of the reflector. The aperture is located directly over the top of the antennae post 14 of the magnetron 12. Other suitable methods of increasing the electric field may also be used. Thus, the high density, low diameter SWNTs irradiated in a relatively high electric field produced a plasma. However, no energy gain was observed. Without wishing to be bound by a particular theory, it is believed that the electric field induced in the nanotubes was not sufficiently high to produce the energy gain. In contrast, it is believed that the electric field in examples 1-25 illustrated in Tables 1-5 and 8 above was above 10,000 V/cm due to the microwave source and sample configuration.

Regarding experiments with Rossetter Holdings MWNTs with very narrow inner diameters (i.e., dual wall MWNTs with about 0.9 nm inner diameter), the energy release was so rapid (i.e., about 1/10 the time for SWNTs) that it results in a thermal shock which shatters the tube containing the nanotubes. The shattering of the nanotube and the splatter of the SiO₂ packing material prevented an accurate estimation of the energy release. It is believed that a net energy gain (positive net energy release) is also present with narrow inner diameter MWNTs, but it could not be quantified due to shattering of the tubes.

The factor of 10 or less energy gain described with respect to examples 1-25 above and no energy gain for the larger diameter nanotubes of comparative examples 1-30 are an extremely conservative lower limit because it neglects heat removed from the tube by air convection, heat losses from the intense broadband photon radiation and the assumptions that all of the radiated microwave power, actually broadcast over a hemisphere, is totally directed at the small SWNT volume (<1 cm³) and absorbed with 1000 efficiency. Independent resonant cavity measurements of the same SWNT materials that give the anomalous heat emission show, in fact, that only about 15% absorption of the power directly incident on the sample at 2.45 GHz. Applying this absorption factor changes, the minimum energy gain increases from a factor of about 10 to a factor of about 60. Furthermore, if the wide area radiation pattern is factored in, then the energy gain would increase even higher than a factor of 60, such as a factor of about 100 to about 1000.

An energy gain of a factor of about 1,000 can be estimated from the following calculation. The input microwave power for a 50 W microwave source at sample volume of about 3 cm³ provides a total input microwave power, corrected for solid angle, of about 40 W. Thus, the power absorbed by the nanotubes is about 40 W after the about 0.3 absorption cross section is taken into account. Thus, for about a 3 second microwave irradiation, the input microwave energy, Q_{IN}, equals to (40 J/s)(3 s)=120 J=0.12 kJ.

The output energy may be estimated as follows. From the first law of thermodynamics, Q_{OUT}=Q_{IN}. Thus, Q_{OUT}=Q_{HEAT TUBE}+Q_{MELT SiO2}+E_{RADIATION}+Q_{CHEM REACTIONS}+Q_{?}. The values of Q_{HEAT TUBE}, E_{RADIATION}, Q_{CHEM REACTIONS} and Q_{?} are assumed to be greater than zero (i.e., for only endothermic reactions, if any, occurring). The heat absorbed to raise the temperature of the SiO₂ to the melting point and the heat required to complete melting is provided by Q_{MELT SiO2}=Q(heat to mp)+Q(melt).

Q(heat to mp)= [symbol] H° (298→˜1900)=1900

∫Cₚ(T)dT=H°₁₉₀₀−H°₂₉₈=111−5 kJ/mol. 298

Thus, Q(heat to mp)=111.5 kJ/mol (far SiO₂ crystal based on data from NIST Standard Reference Database 69, 0312003 Release: NIST Chemistry WebBook). Q(melt)= [symbol] H°_{MELT} (SiO₂, crystal)=9.6 kJlmoi (based on data from Handbook of Chemistry and Physics, 81St ED, David R. Lide, Ed, CRC Press, NY, 2000). Thus, Q_{MELT}=Q(heat to mp)+Q(melt)=111.5+9.6=121.1 kJ/mol.

The thermal balance of the input microwave energy and the minimum output energy may be provided as measured by the melting of the SiO₂ and the radiation. The value of the latter quantity is not given but clearly it is positive since intense optical and ultra-violet radiation is observed to come from the sample. The result of the balance is that insufficient energy is inputted from the microwave source to account for all the energy flowing out of the nanotube sample.

Thus, energy Q_{OUT}=heating of surroundings+heat of phase transitions+radiation+energy associated with chemical reactions (+ or −). In other words, Q_{OUT}=Q_{HEAT SYSTEM}+′QM_{ELT SiO2}+E_{RADIATION}+Q_{CHEM REACTIONS}=>111.5+9.6 kJ/mol+>0+>0. Thus; Q_{OUT}>121 kJ/mol. For 60 g of SiO₂ (=1.0 mol), Q_{OUT}>121 kJ. Thus, the ratio of input energy to output energy exceeds 1000: Q_{OUT}/Q_{IN}> (121 kJ)1(0.12 kJ)˜10₃. Thus, an energy gain factor of 10 to 1,000 may be achieved by irradiating the nanotubes with microwaves.

The above specific examples establish that microwave irradiation of single wall carbon nanotubes under vacuum conditions can cause intense emission of light, ranging from UV to near IR wavelengths, and heat output that significantly exceeds the total input power of the microwave fields by at least an order of magnitude. However, the underlying mechanisms for this effect have not been conclusively established.

Without wishing to be bound by a particular theory, the energy gain may occur because the microwave irradiation of nanotubes may excite phonon and electron resonances. Furthermore, potential quantum effects, such as quantum fluctuations of the EM field trapped in the nanotubes, triggered by the quasi-11D geometries of the small diameter nanotubes may also be responsible for the energy gain. Furthermore, it is possible that carbon tips act as pin point electron field emitters, which contribute to the effect. Low energy 2.45 GHz radiation can induce excitation of the system to produce electron temperatures of about 5000-6000 K with accompanying photon emission at UV frequencies, an upconversion of >10⁵. The nanotube structures unexpectedly remain intact at high electron temperatures given estimates of about 4000 K for the disintegration threshold. Thus, the conversion of microwave energy to thermal energy (as well as to UV, visible and IR radiation emission) may be generated continuously, such as for at least 10 minutes to 1.5 hours, for example between 10 minutes and 10 hours, without destroying a structural integrity of the nanotubes. The energy conversion continues until the nanotubes are destroyed or until the container holding nanotubes is breached by the heat emitted by the nanotubes. Furthermore, if the nanotubes are heated at a temperature of 1500° C. or above, the diameters of the nanotubes double and then quadruple which eventually terminate the energy conversion. Thus, nanotubes may be heated at a temperature of below 1500° C., such as about 1300° C. for long term, continuous energy conversion. In order to provide long term energy gain from microwave irradiation of nanotubes, the nanotubes may be continuously replaced or cycled in the zone of microwave irradiation. Thus, the nanotubes may be placed in a fluid, such as a liquid or a gas, which cycles nanotubes through the microwave irradiation zone. As the nanotubes increase in diameter after a period of microwave irradiation, they are replaced with other nanotubes of a sufficiently small diameter to continue to convert microwave energy to thermal energy, preferably with an energy gain.

ENHANCED PLASMA. In prior sections, plasmas were explained and shown to exist as a result of the interaction between the material containing a nanoscale sized space therein, such as carbon nanotubes, with microwave or radio frequency radiation. In the examples that will be described below, the plasma temperature is believed to have reached ion temperatures higher than 1 keV and blackbody temperatures that are above that of the surface of the sun (which is about 6000 K) or about 10,000 degrees Kelvin or greater. For example, the ion temperatures range from 10 keV to about 12 keV, for example and the blackbody temperatures range from about 6000 K and higher, such as from about 10,000 K to about 12,500 K. The following discussion and examples explain and demonstrate the high ionization state, high temperature plasma generation in these nanoscale materials.

FIG. 8 illustrate a spectra of carbon nanotubes irradiated by microwave radiation. The blackbody temperature of the plasma which produced the spectra in FIG. 8 is estimated to be at least 10,000 degrees Kelvin and the ion temperature of this plasma is estimated to be at least 500 eV, such as between 1 keV and 12 keV from the characteristic plasma lines in the spectra, as will be described in more detail below.

FIG. 8 shows an exemplary spectra ranging from 180 to 480 nm from several data runs which are assigned random numbers. Specifically, FIG. 8 shows the spectra for five runs given random numbers 60, 61, 62, 63 and 64. The spectrum of each run is divided into four wavelength ranges, a, b, c, and d, as will be explained below.

An expanded spectrum ranging from 220 nm to 1020 nm for the data run 64 is shown in FIG. 8. Many different line emissions (i.e., peaks) are visible in FIG. 8. From about 500 nm to 1020 nm a broad band type emission can be seen. As shown in FIG. 8, the 64a portion of the spectrum extends from 220 nm to 520 nm, the 64b portion of the spectrum extends from below 520 nm to above 720 nm, the 64c portion of the spectrum extends from below 720 nm to between 920 and 1020 nm, and the 64d portion of the spectrum extends from above 920 nm to above 1020 nm.

In the case of the plasma observed in the present example, four very high temperature ions were detected. Those ions are C VI (489.981 eV), N VI (552.057 eV), Ti XIX (about 12 keV), Fe XVI (1.1362 keV). Since N, Ti and Fe are known impurities in HiPCo nanotubes, it is not surprising that in addition to C ion lines, N, Ti and Fe ion lines can be found in the spectra.

The C, N, Ti and Fe ion lines are identified from the spectra using the following method. In general, the highest ionized state in the system for a particular ion is determined from the spectra and then compared to values in known data tables to identify the ion species and state. Then, the corresponding temperature of that ion is determined from a known reference listing the ion temperatures.

Specifically, the method includes the following steps. For each data run, the center wavelength of each emission line or peak is identified. The placement of the center frequency of these lines is what is used to determine the ionized species. The line or peak width can also be used to determine the identity of the ionized species, as certain lines have a characteristic width to them. For example, many hydrogen lines are not as wide as carbon lines.

Then, the identity of each peak or line (i.e., the element and the ionization state responsible for the peak) is determined by consulting the atomic emission database at the National Institute of Standards and Technology (httg://physics.nist.gov/cgi-bin/AtData/lines form). The database contains a list of known peaks or lines and intensities for various elements and ionization states. The search of the database is limited to options (i.e., elements) which could possibly be present in the sample (i.e., carbon, known impurities in carbon nanotubes and any dopant elements intentionally introduced into the nanotubes).

Occasionally it will be found that one peak or line will have two potential assignments in the database. In these cases, the spectral line in question has its intensity plotted versus time along with known emission peaks. If the temporal location of the peak intensity is the same for an unknown and a known line in the database, then they will be the same element and ionized state. If the behavior differs, then it is still not possible to assign the candidate line to a particular ion. This analysis was repeated for many data runs where the high ionization plasma reaction was observed, and many lines can be very accurately assigned to particular ionization states for various elements. To verify the peak or line assignment, the nanotubes in some runs have been doped with different amounts of a dopant, such as additional hydrogen. In these cases, more of the dopant element will be seen in the plasma spectra in the form of more intense peaks at the wavelengths assigned to the ionization state of the dopant element.

FIG. 8 shows examples of how the ionization states of C, N, Ti and Fe were identified. FIG. 8 includes close ups of various wavelength ranges shown. Thus, the 227.089 nm peak shown in FIG. 8 is assigned to C VI (489.981 eV), the 962.200 nm peak shown in FIG. 8 is assigned to VI (552.057 eV), the 609.22 nm peak shown in FIG. 8 is assigned to Ti XIX (−12 keV), and the 477.17 nm peak shown in FIG. 8 is assigned to Fe XVI (1.1362 keV). The ionization energies provided in the previous sentence are known for the particular ionizations states of particular ions, and can be found in many references including the Handbook of Chemistry and Physics.

The peaks or lines identified in FIG. 8 are seen in a selected number of runs, especially in runs with the higher electric fields. These peaks or lines also appear and disappear several times during a data run. In other words, these peaks or lines may be seen in spectra taken at time x during an experiment and may not be seen at time x+y or x−y, for example. Specifically, the high ionization state lines or peaks tend to appear later in a data run after peaks or lines assigned to lower ionized states have the time to form. This type of behavior is to be expected with the highly ionized states because the ionized atom will be very attractive to any free electron and one will reattach very quickly. The lines or peaks do reappear several times in data runs for which it is present.

Thus, the plasma ion temperature is higher than 500 eV, such as higher than 1 keV, such as higher than 10 keV, for example 552 eV to 12 keV. The blackbody temperatures that can be inferred from the optical spectrometry are higher than the blackbody temperature of the surface of the sun or about 10,000 Kelvin or greater, such as 10,000 to 12,500 K, for example.

The samples used to generate the plasma in FIG. 8 are purified, intentionally undoped BuckyPearl® SWNTs, having a diameter of about 1.1 nm or less. The vacuum level reached is about 10⁻⁶ torr when the reaction began. The spectra shown in FIG. 8 is taken about 3 seconds into the data run (i.e., about 3 seconds after the irradiation of the nanotubes began). The plasma reaction can be maintained for longer than 3 seconds. The longer into the data run the higher the ionized state, and the higher temperature that will be reached by the resulting plasma. The other experimental parameters were the same as described above. The frequency, microwave power and electric field used in generating the spectra shown in FIG. 8 are believed to be 2.45 GHz at 300 Watts and about 15,000 Volts/cm, respectively.

The high ionization state and high temperature plasma of this example may be generated by any suitable method described above, provided that the method is preferably configured as described above to increase the electric field value to aid in the formation of the high temperature plasma. Preferably, to increase the electric field, the nanotubes are placed in the near field region (less than 10 mm, preferably less than 4 mm from the source to sample) and the above described reflector with an aperture is placed on the front surface of the microwave antennae to achieve high level refractive electric fields. If desired, the electric field will also increase with the use of a resonant device such as a tapered waveguide or resonant cavity type device. Thus, an electric field of greater than 10,000 V/cm, such as about 13,000 to 16,000 V/cm and a power below 2,000 Watts, such as 300 to 1300 Watts, is preferably used to generate the high ionization state and high temperature plasmas.

The highly ionized plasma may be generated in either intentionally doped nanotubes or intentionally undoped nanotubes which may have unavoidable impurities present therein. The nanotube doping may be achieved by ion implantation, such as by the method described in U.S. patent application Ser. No. 10/764,092, published as U.S. Published Application No. 2004/0180244. U.S. patent application Ser. No. 10/764,092 is incorporated herein by reference in its entirety. If dopant ions of the desired species are incident upon the nanotube matrix they will tunnel through one side of the nanotube but not the other thereby being entrapped in the inner volume of the nanotube. They are stored there long term by the fact that the hole that will be ‘ripped’ in the nanotube will self heal in approximately 1 picosecond so the entrapped ion will not be able to escape. Thus, by intentionally doping the nanotubes with desired atoms, a plasma containing ions of these atoms may be generated. The high temperature plasma is formed in the nanotubes and anything in the nanotube matrix, including carbon, impurities and optional dopants will be ionized. This reaction can also be run with nanotubes purposely doped with various materials all of which will reach similar ionized states.

It should be noted that the high ionization states of the ions in the plasma whose spectra is shown in FIG. 8 are not unique. They can be achieved in several different ways. However, it is believed that in the prior art, very high power levels were required to reach the high ionization states. For example, it is believed that in order to achieve these high ionized states in the prior art using a microwave field required either very high power levels (megawatt range typically) or some slightly lower power level (100,000 Watts or so) in combination with either pumping on a natural resonance of the media to be turned into the plasma state or achieving some resonant condition. In the case of the present example, the high ionized states can be achieved with microwave powers far less than 2,000 Watts, such as 300 to, 300 Watts.

Without wishing to be bound by a particular theory, it is believed that the high electric field provided by the experimental configuration described above leads to a linear accelerator behavior by the nanotubes to achieve the high ionization states observed in the plasma whose spectra is shown in FIG. 8. Thus, the method of the present examples allows the formation of a plasma with high ionization states and high temperature using relatively low power microwave irradiation.

Without wishing to be bound by a particular theory, the carbon nanotubes may be acting as small (i.e., nanoscale) linear accelerators which initiate a plasma reaction. First, the basic components of large-scale classic (i.e., prior art) linear accelerators (“linacs”) will be described. Then, the mechanism of nanoscale linear accelerators will be described.

There are many possible linear accelerator designs, depending on the energies one wants to reach. However they all have the following structure in common. The linear accelerators contain a substantially straight or linear tube. Charged particles are injected into this tube and accelerated, usually in packets. The reason for the tube being linear is that any bending of particle orbits will cause synchrotron radiation emission from the particles, and so lose enough energy to stop the linear accelerator. Thus, the problem in prior art, large scale linear accelerators is how to couple accelerating electric fields to the particle packet and how to create electromagnetic lenses to keep the packets from hitting the tube walls.

In the largest prior art linear accelerators, this problem is solved with a series of powerful microwave cavities staged in a line along the tube. Power from strong RP fields is phased so packets are all accelerated in the same direction, as well as acting as focusing lenses. Thus, the prior art linear accelerators require a lot of power and complex components to operate.

However, in some examples, nanotubes, such as carbon nanotubes, may be considered to be a nanoscale “copy” of the large scale linear accelerator arrangement, as if the linear accelerator had been shrunk to nanometer scale diameters, with a mean length of order microns. There are some differences and some additional properties of nanotubes, which give them an advantage over large-scale, prior art linear accelerator machines.

Since nanotubes behave as either conductors or semiconductors, it is known from both molecular dynamics simulations and the theory of nonmetallic conductors, that the smeared electron clouds of each carbon atom have a dipole shape, the dipole being transverse to the nanotube, with half of it extending far into the tube providing a natural and very powerful electrostatic field which acts like a focusing lens. These are called Pi orbitals. In addition, there is a strong repulsive force near the walls of the nanotube which prevents all but the most energetic particles (order a GeV) to escape. This is why it is preferable to keep the internal diameters of the nanotubes small, such as on the order of 1 to 1.1 nanometers or less.

Without wishing to be bound by a particular theory, it is believed that for multi-wall nanotubes, such as double wall nanotubes, the space between the nanotube walls (i.e., the space between the inner and outer wall of a double wall nanotube) may also be used as the linear accelerator cavity. These spaces typically have a width of below 1 nm, such as about 0.5 to about 0.7 nm. In this case, it may be possible to achieve some of the effects described herein in multi-wall nanotubes that have an inner diameter than is greater than 1.1 nm, since the interwall spacing in these nanotubes is less than 1 nm. Thus, SWNTs with internal diameters of 1.1 nm or less and MWNT including double wall nanotubes, preferably with internal diameters of 1.1 nm or less are used as linear accelerators. Other nanostructures, such as nanohorns, etc., which contain nanometer sized or smaller internal space and a linear length portion may also be used as nanoscale linear accelerators.

Without wishing to be bound by a particular theory, it is believed that the entire length of a nanotube does not have to be straight or linear for the nanotube to act as a nanoscale linear accelerator. Nanotube samples contain billions of nanotubes, which contain kinks, imperfections, twist-ons and other non-linear regions. However, portions of the nanotubes in these samples are straight or linear. For example, BuckyPaper or BuckySpheres (i.e., compressed SWNT BuckyPaper which is placed in a water/acetone solution, shaken for several hours (4-5 hours for example) and compressed into roughly spherical shape) contain nanotubes with both straight (i.e., linear) and kinked regions. Thus, a particular single nanotube may have a kinked portion and a straight portion along its length. The linear portions of the nanotubes are believed to be sufficient to act as the linear accelerator with the charged particles or species being accelerated in the these linear or straight portions. It is noted that completely linear nanotubes are also available. These nanotubes are produced using an aligning magnetic field or various selective deposition methods on various substrates. Often these nanotubes are aligned in the same direction in the nanotube samples. It is believed that the entire length of such linear and aligned nanotubes may be used as a linear accelerator. Alternatively, it is possible to purposefully deform the nanotubes in a sample using various known deformation techniques.

Without Wishing to be bound by a particular theory, it is believed that one property of nanometer sized nanotubes that is used to create very efficient accelerators and colliders is dimensional squeezing. In large machines that must confine particles, arrangements of electrostatic lenses and magnetic confining fields have a large amount of particle leakage because particles can move in three dimensions, escaping the focusing region. This allows many types of hydrodynamic instabilities, which cause such machines to be expensive, wasteful and difficult to control. Large particle accelerators have severe problems of this kind.

In nanotubes with roughly 1 nanometer diameter (or other nanostructures) containing internal spaces of 1 nm or less, using Pi orbitals and strong repelling fields near the walls of the tube, particle orbits are effectively confined in both space dimension and in momentum space to a dimension near one. There is no room for transverse momentum to build up, so the charged particles or species experience no instabilities. It is believed that at worst, the charged particles or species move in (i.e., are accelerated through) long spiral orbits in the nanoscale space. It is believed that the charged particles or species that are accelerated in the nanotubes include at least one of ions and electrons.

Thus, very large efficiencies are gained in accelerating charged particles or species in nanoscale structures instead of in larger machines, since dimensional squeezing is automatic in a nanoscale structure. For example, this may be considered to be similar to a thin light ray being shot down the tube.

The energy and an accelerating electric field may be coupled in the same direction to the charged particles or species in the nanotubes using various external stimuli. As described above, microwave radiation or even RF fields having a frequency close to the microwave region may be used to accelerate charged particles or species in linear nanotube portions. Microwave irradiation of nanotube samples, such as BuckyPaper or BuckySphere samples is a bulk process. Thus, it is possible to obtain the high electric fields in the nanotubes to generate an energy gain and a plasma in a large nanotube sample volume without ultra-fast microwave radiation switching and without the need to align all nanotubes in a sample in the same direction, as demonstrated by the above described examples.

It is believed that other electromagnetic radiation, such as visible range, infrared (IR) or ultraviolet (UV) radiation may also be used to induce or generate linear accelerator behavior in nanostructures, such as nanotubes. For example, visible, IR and UV lasers may be used to induce or generate linear accelerator behavior in nanostructures, such as nanotubes. While lasers are provided as an example, other radiation sources may also be used.

Since laser irradiation of nanotubes is believed to be a more localized process than microwave irradiation of nanotubes, it is believed that the nanotubes should be aligned in the same direction to generate or induce the linear accelerator behavior in nanotubes which are subjected to laser radiation. Furthermore, it believed that a high power, fast switched pulsed laser should be used to generate or induce the linear accelerator behavior in nanotubes.

As discussed above, nanotubes may be created in a disordered mass with random orientation. There are however well known techniques for growing them in either high magnetic fields and/or on certain substrates or templates so they form ordered arrays or matrices of tubes. See for example, Z. J. Zhang, B. Q. Wei, G. Ramanath, P. M. Ajayan, Appl. Phys. Lett. 77, 3764 (2000); W. Z. Li, et a[. Science 274, 1701 (1996); R. Sen, A. Govindaraj, C. N. R. Rao, Chem. Phys. Lett. 267, 276 (1997); M_ Terrones, et al. Nature 388, 52 (1997); Z. F. Ren, et al. Science 282, 1105 (1998); S. S. Fan, et al. Science 283, 512 (1999); H. Kind, et al. Adv. Mater. 11, 1285 (1999); R. R. Schlittler, et al. Science 292, 1136 (2001) and L.®ai, A. W. H. Mau, J. Phys. Chem. B 104, 1891 (2000), all incorporated herein by reference in their entirety.

The dynamics of a single nanotube in an array of aligned nanotubes under intense laser irradiation will now be discussed. Lasers can generate extremely high electric field strengths. For example, there are numerous large laser systems around the world that routinely generate over ten million volts per nanometer. Such lasers may generate an output power over 1 terawatt, such as 1-30 terawatts, and have a frequency of over 1 terahertz. Thus, it may be possible to perform complete acceleration of a charged particle or species along the length of a nanotube without complex phasing with a high power laser.

For example, a high power, high frequency YAG laser may be used as the radiation source to induce or generate linear accelerator behavior in nanotubes. If a particle or packet is “kicked” or excited with a high power YAG for very short times, making sure the electric field is always in the same direction, linear acceleration in nanotubes may be achieved. This is done by using special laser triggered switches, such as silicon switches, that can switch tens of thousands of amps at tens of thousands of volts in under a nanosecond. There are several similar switches available.

In contrast, if a moderate power, pulsed YAG laser is used, linear accelerator behavior may not be reached. The photon frequency of such a laser is roughly 300 terahertz. Attempts to excite a nanotube or the electrons in it, is believed to achieve a result which is so far off from nanotube mechanical resonance that the nanotube coupling is minimal. It is believed that nanotube mechanical resonance occurs in a frequency range that is less than several hundred gigahertz, for example equal to or less than 100 megahertz, which is orders of magnitude lower than the about 300 terahertz photon frequency of a YAG laser. The oscillating electric field from the laser will trap a charged particle or specie, such as an electron, in a very small volume where it locks onto the electric field and oscillates. This will cause the electron to emit synchrotron radiation of a very high frequency, but does not cause substantial movement. This is believed to be a novel way of creating a free electron laser. It lower frequencies are achieved by amplitude modulation of the laser, either by beating two lasers together or using a microwave laser modulator, again the electron or electron packets will not move down the tube. The modulator simply turns on or off over the carrier.

The above described method and apparatus is believed to solve the coupling and accelerator problem and provide a nano linear accelerator with many useful applications. Thus, carbon nanotubes can be used as natural self assembled linear accelerators and can be driven efficiently either by microwaves or by lasers.

Thus, it is believed that the nanotubes act as linear accelerators for charged particles or species, such as ions or electrons that are either located in the inner pores (inside volume) of the nanotubes or other nanostructures or located between the walls of multi-wall nanotubes. The ions may comprise carbon ions, impurity ions, such as impurities which are unavoidably present from the process of forming the nanotubes, or intentionally added dopant ions. For example, impurities include metal catalysts, such as iron, titanium or copper, used in the fabrication of nanotubes, as well impurities provided from the atmosphere, such as hydrogen, nitrogen or oxygen. Dopants include any desired atoms or molecules, including but not limited to hydrogen, deuterium, tritium, helium, lithium, nitrogen, oxygen, iron, titanium, etc. Furthermore, the nanotube linear accelerator may be used to emit a charged particle or specie beam, such as a proton, ion or electron beam. This may be accomplished by removing an end or tip portion of the nanotube using various known chemical cutting or cleaving methods such that the nanotube is open on one or both ends. The charged particles or species are then accelerated in one direction in the inner volume of the nanotube by the long wavelength radiation until they are ejected as a particle or specie beam from the open end of the nanotube. Thus, the open end or tip of the nanotube should be adjacent to the straight or linear portion of the nanotube. Thus, the nanotube can be used as a nanoscale sized electron, proton or ion beam source for any application where such a beam is desirable. For example, an electron beam may be used for nanoscale electron microscopy, such as in an ultra high resolution scanning or tunneling electron microscope, or for irradiation and exposure of an electron sensitive material, such as an electron beam sensitive resist, used in electron beam lithographic patterning of semiconductor or other solid state devices. An ion beam may be generated from a nanotube doped with any suitable ions. The nanoscale ion beam may be used for highly precise, low dose local area ion implantation of semiconductor or other materials. Thus, the nanotubes may be used in electron microscopy, electron beam lithography or ion implanter systems, for example. If a sample is provided containing a plurality of nanotubes aligned in the same direction with exposed open ends or tips pointing in the same direction, then a larger diameter charged particle or specie beam with a higher flux may be generated from such a sample than from a single nanotube. If the nanotubes are aligned or facing in two or more different directions with the open ends or tips pointing in two or more different directions, then a plurality of charged particle or specie beams may be emitted in a plurality of different directions. It is possible that the charged particle or specie beam will contain a plurality of different particles or species that are present in the nanotube or nanotubes, such as a combination of electrons, protons and/or one or more different ions.

It is known from literature that the common impurity elements in a typical sample of HiPCo nanotubes are Fe, C, O, H, N, He, Cl, Cu, Ti and Si. See “The role of impurities in the interaction of carbon nanotubes with microwave radiation,” F. Naab, O. W. Holland, T. Imholt, F. D_ McDaniel, J. Duggan, and J. Roberts, Proceedings of the 10{x′ International Conference on Particle Induced X-Ray Emissions and its Analytical Applications, June 2004, LjubljanaPortoroz, Slovenia and L. P. Biro, N. O. Khanh, Z. Vertesy, Z. E. Horvath, Z. Osvath, A. Koos, J. Gyulai, A. Kocsonya, Z. Konya, X. B. Zhang, G. Van Tendeloo, A. Fonseca, J. B. Nagy, “Catalyst traces and other Impurities in chemically purified carbon nanotubes grown by CVD,” Materials Science and Engineering, 19 (2002) 9-13. These impurities can be detected by Rutherford Backscattering Spectroscopy (RBS) or Particle Induced X-Ray Emission Spectroscopy (PIXES). These elements can be observed in the plasma spectra as a result of their presence in the sample. The following are the concentration of impurities in the HiPCo nanotubes as described in the literature:

Fe—1 part per 10,000

C—inherent in the sample as they are carbon nanotubes

O—1 part per 100,000

CI—1 part per 1,000,000

Cu—1 part per 10,000,000

Ti—1 part per 1,000,000

Si—1 part per 1,000,000

H—can't be seen by PIXES or RBS but is known to be in sample

N—can't be seen by PIXES or RBS but is known to be in sample.

Therefore, it is not surprising that N, Ti and Fe plasma lines have been identified in spectra of undoped HiPCo SWNTs shown in FIG. 8.

APPLICATIONS. The energy generated by a first material, such as the nanotubes, which is irradiated by the long wavelength radiation, is provided to a second material. The second material is different from the first material and the second material may be located adjacent to the first material. The second material may comprise a portion of any suitable device or article of manufacture. Exemplary devices and articles which utilize the energy generation are described in U.S. patent application Ser. No. 10/764,092, published as U.S. Published Application No. 2004/0180244. U.S. patent application Ser. No. 10/764,092 is incorporated herein by reference in its entirety.

When carbon nanotubes are placed in an EM field in the microwave and radio frequency region, carbon nanotubes can sustain charged particle plasmas that can reach temperatures of at least as high as 5000 Kelvin. Furthermore, these temperatures are attained within a second. These plasmas generate intense or hyper bright light that can be as bright as a typical welding arc, generally estimated to be equivalent to a temperature of approximately 6000 Kelvin and higher. The production of hyper bright plasmas from carbon nanotubes exposed to electromagnetic irradiation provide a method for providing remotely controlled extremely bright light produced instantaneously at the location where the carbon nanotubes are placed. By placing the carbon nanotubes in a non-oxidizing ambient at specific locations (very high E-field points) within the volume of an object that can be penetrated by a remotely controlled EM field, the plasmas will be created at those locations and subsequent irradiation of bright light will bathe and radiate from those regions. Further, by selecting the amount of carbon nanotubes to be placed at a desired location, the intensity of the desired effect can be precisely regulated. By selecting the power of the applied EM field, the intensity of the desired effect can be precisely regulated.

The placement of carbon nanotubes at specific locations followed by controlled irradiation by selected frequencies of electromagnetic fields advantageously allows the delivery of remotely controlled plasma, light and heat instantaneously to regions within an object. This feature can be used to initiate chemical reactions or physical processes at that exact location. Since a single carbon nanotube should be able to sustain a plasma, the size or volume of a single location to receive the light from a carbon nanotube may be on the order of the size of the carbon nanotube and thus at the scale of a nanometer in diameter and up to the length of the carbon nanotube.

This process of releasing thermal energy and generating a plasma, and the apparatus used to implement it, facilitates numerous improvements of existing applications, such as for use in engines and power production plants, and gives rise to novel methods of medical treatments. For example, these above described behavior of nanotubes in EM fields may be useful in a power plant for example. In this case, the nanotubes and the EM field source are provided in conjunction with an apparatus which can convert the plasma generated in the nanotubes to electrical energy or power. When one batch of nanotubes is exhausted (i.e., no longer provides an energy gain and plasma due to diameter doubling or other physical change), it is replaced with a fresh batch of nanotubes, similar to the way coal or other fuel is replenished in a conventional power plant. Since MWNTs are fairly inexpensive and provide megawatts of power, they can be used as fuel in a power plant instead of coal or other hydrocarbon fuels, using the above described energy gain or generation methods.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A method for controlling a chemical process, comprising:
receiving a catalytic materials composition, the catalytic materials composition comprising at least one catalyst material and at least one reactant material;
adding nanostructure material to the catalytic materials composition, the nanostructure material comprising at least one nanoscale-sized space therein; and
irradiating the nanostructure material with electromagnetic radiation such that the nanostructure material facilitates energy transfer between the nanostructure material and the catalytic materials composition.

2. The method of claim 1, wherein irradiating the nanostructure material further facilitates generating plasma about the nanostructure material.

3. The method of claim 2, the plasma further comprising ionic plasma.

4. The method of claim 3, wherein the ionic plasma comprises at least one of a carbon plasma and a plasma of species present in the nanostructure material.

5. The method of claim 4, wherein the species present in the nanostructure material comprises at least one of impurities and dopant atoms.

6. The method of claim 2, wherein the ion temperature of the plasma comprises at least 1 KeV.

7. The method of claim 1, wherein the nanostructure material comprises carbon nanotubes.

8. The method of claim 7, wherein the carbon nanotubes are carbon single-walled nanotubes.

9. The method of claim 7, wherein the carbon nanotubes are carbon multi-walled nanotubes.

10. The method of claim 7, wherein the carbon nanotubes have an inner diameter of 1.1 nanometers or less.

11. The method of claim 1, wherein the electromagnetic radiation comprises microwave radiation.

12. The method of claim 1, wherein the electromagnetic radiation comprises visible, infrared, or ultraviolet radiation.

13. The method of claim 1, wherein:
the electromagnetic radiation comprises pulsed microwaves; and
the nanostructure material is restrained from moving during the irradiation with the pulsed microwaves.

14. The method of claim 1, wherein the electromagnetic radiation induces an electric field of at least 10,000 Volts per centimeter in the nanostructure material.

15. The method of claim 14, wherein an energy and the electric field are coupled in a same first direction to charged particles or species located in the nanostructure material such that the charged particles or species are accelerated in the first direction in a linear portion of the at least one nanoscale-sized space.

16. The method of claim 14, wherein the electric field comprises 11 to 16 kV/cm and the nanostructure material comprises highly-dense nanotubes.

17. The method of claim 13, wherein the microwave power is 2,000 Watts or less.

18. The method of claim 17, wherein the microwave power is 300 to 1300 Watts.

19. The method of claim 1, wherein the energy transfer is thermal energy transfer.

20. The method of claim 1, wherein the catalyst material comprises a heterogeneous catalyst.

21. The method of claim 1, wherein the energy transfer adds more energy to the catalytic materials composition than is needed to sustain a reaction of the catalytic materials composition.

22. The method of claim 1, further comprising storing the excess transferred energy in an energy storage medium.

23. The method of claim 22, wherein the energy storage medium is a battery charged by a photovoltaic.

24. The method of claim 22, wherein the energy storage medium is further operable to provide electrical or mechanical power.

25. The method of claim 24, wherein the energy storage medium is a photovoltaic cell or a Stirling engine.

26. A system for controlling a chemical process, comprising:
a reaction chamber comprising:
a catalytic materials composition, the catalytic materials composition comprising at least one catalyst material and at least one reactant material, and
nanostructure material, the nanostructure material comprising at least one nanoscale-sized space therein; and
an energy source operable to irradiate the nanostructure material with electromagnetic radiation such that the nanostructure material facilitates energy transfer between the nanostructure material and the catalytic materials composition.

27. The system of claim 26, wherein irradiating the nanostructure material further facilitates generating plasma about the nanostructure material.

28. The system of claim 27, the plasma further comprising ionic plasma.

29. The system of claim 28, wherein the ionic plasma comprises at least one of a carbon plasma and a plasma of species present in the nanostructure material.

30. The system of claim 29, wherein the species present in the nanostructure material comprises at least one of impurities and dopant atoms.

31. The system of claim 27, wherein the ion temperature of the plasma comprises at least 1 KeV.

32. The system of claim 26, wherein the nanostructure material comprises carbon nanotubes.

33. The system of claim 32, wherein the carbon nanotubes are carbon single-walled nanotubes.

34. The system of claim 32, wherein the carbon nanotubes are carbon multi-walled nanotubes.

35. The system of claim 32, wherein the carbon nanotubes have an inner diameter of 1.1 nanometers or less.

36. The system of claim 26, wherein the electromagnetic radiation comprises microwave radiation.

37. The system of claim 26, wherein the electromagnetic radiation comprises visible, infrared, or ultraviolet radiation.

38. The system of claim 26, wherein:
the electromagnetic radiation comprises pulsed microwaves; and
the nanostructure material is restrained from moving during the irradiation with the pulsed microwaves.

39. The system of claim 26, wherein the electromagnetic radiation induces an electric field of at least 10,000 Volts per centimeter in the nanostructure material.

40. The system of claim 39, wherein an energy and the electric field are coupled in a same first direction to charged particles or species located in the nanostructure material such that the charged particles or species are accelerated in the first direction in a linear portion of the at least one nanoscale-sized space.

41. The system of claim 39, wherein the electric field comprises 11 to 16 kV/cm and the nanostructure material comprises highly-dense nanotubes.

42. The system of claim 38, wherein the energy source provides microwave power that is 2,000 Watts or less.

43. The system of claim 42, wherein the energy source provides microwave power that is 300 to 1300 Watts.

44. The system of claim 26, wherein the energy transfer is thermal energy transfer.

45. The system of claim 26, wherein the catalyst material comprises a heterogeneous catalyst.

46. The system of claim 26, wherein the energy transfer adds more energy to the catalytic materials composition than is needed to sustain a reaction of the catalytic materials composition.

47. The system of claim 26, further comprising an energy storage medium operable to store the excess transferred energy.

48. The system of claim 47, wherein the energy storage medium is a battery charged by a photovoltaic.

49. The system of claim 47, wherein the energy storage medium is further operable to provide electrical or mechanical power.

50. The system of claim 49, wherein the energy storage medium is a photovoltaic cell or a Stirling engine.
